(19) United States
(12) Patent Application Publication
(10) Pub. No.: US 2018/0369817 A1
(43) Pub. Date: Dec. 27, 2018

(54) SYSTEMS, DEVICES AND METHODS OF PERFORMING MAGNETOPHORETIC SEPARATION AND SOLUTION EXCHANGE IN CURVED FLUIDIC CHANNEL

(71) Applicants: Pouya REZAI, Maple (CA); Pouriya BAYAT, Toronto (CA)

(72) Inventors: Pouya REZAI, Maple (CA); Pouriya BAYAT, Toronto (CA)

(21) Appl. No.: 16/015,617

(22) Filed: Jun. 22, 2018

Related U.S. Application Data
(60) Provisional application No. 62/524,219, filed on Jun. 23, 2017.

(51) Int. Cl. B01L 3/00; B03C 1/30; B03C 1/28; G01N 1/38

(52) U.S. Cl. CPC B01L 3/502761; B03C 1/30; B03C 1/288; B03C 1/286; G01N 1/38; G01N 2001/386; B03C 2201/20; B01L 2200/0647; B01L 2300/0861; B01L 2400/043; B03C 2201/18

(57) ABSTRACT

Systems and methods are provided that enable the magnetophoretic separation of magnetic particles using Dean flow in curved fluidic channels. In some example embodiments, a magnetic microparticle solution and a buffer solution are injected into a proximal region of a curved fluidic channel, and channel and fluidic parameters are selected to achieve solution exchange via Dean flow, such that the lateral positions of injected laminar fluid streams are inverted in a distal region of the channel. An applied magnetic field gradient is employed to retain the magnetic microparticles proximal to a channel side wall during the solution exchange process, such that magnetic microparticles are separated into the buffer solution. Various example device configurations are disclosed, including example configurations including one or more additional fluidic components for the further processing of separated magnetic particles.

### TECHNICAL FIELD

The following relates generally to fluidic separation and sample preparation devices, and more specifically, to systems, devices and methods of performing magnetophoretic separation and solution exchange in curved fluidic channel.

### BACKGROUND

Many attempts have been made to integrate various steps of sample preparation on lab-on-a-chip and other microfluidic devices. Exchanging the solution of microparticles can be useful during sample preparation in point-of-care applications. Inertial, acoustic, dielectrophoretic and magnetic methods in straight channels are known, but limited to low particle throughputs (˜1000 particles/sec).

Dean flow in curved microfluidic channels has been employed in various microfluidic devices to produce lateral particle transport within a microfluidic channel, which is employed to achieve particle separation. In such known applications of Dean flow, the lateral transport of particles within a fluid stream is governed by inertial forces.

One example of a conventional Dean flow fractionation device is disclosed by Yao et al. (Yao et al., ACS Appl. Mater. Interfaces 2015, 7, 20855-20864), in which a cell suspension is injected, along with a sheath solution, into a spiral microfluidic channel, with the sheath solution adjacent to the inner wall of the microfluidic channel, and the cell suspension injected adjacent to the outer channel wall. Inertial forces are employed to focus the cells at the inner wall of the microfluidic channel (typically with a ratio of particle size (ap) to channel hydraulic diameter (Dh) of ap/Dh>0.07) while the sample solution flows through the channel to an outlet having dual extraction ports, with one of the ports being configured to collect the portion of the fluid stream adjacent to the inner wall of the microfluidic channel. A full Dean cycle occurs between the inlet and outlet port, so that the cells are collected in the buffer. A similar device is disclosed by Hou et al. (Hou et al., Lab Chip, 2015, 15, 2297-2307). A spiral microfluidic channel, configured for achieving a full Dean cycle, is employed for the inertial separation of red blood cells from bacteria, such that the bacteria are sorted into a sheath solution.

S. Dutz et al. (Dutz S, Hayden M E, Hafeli U O (2017) Fractionation of Magnetic Microspheres in a Microfluidic Spiral: Interplay between Magnetic and Hydrodynamic Forces. PLoS ONE 12(1): e0169919. doi:10.1371/journal.pone.0169919) have disclosed the implementation of a spiral microfluidic channel for inertial-based particle sorting of magnetic microparticles, in the absence of solution exchange in buffer solution, in which a magnetic field gradient is applied in order to supplement the inertial forces applied to the magnetic microparticles as they flow through the microfluidic channel. Dutz et al. provides a magnetic field gradient having a strength such that at low flow sample rates, in the range of 0-20 μL/min, magnetic forces dominate over inertial forces, while at larger flow rates, in the range of 40-80 μL/min, inertial forces dominate over inertial forces.

### SUMMARY

In an aspect, there is provided a fluidic system comprising: a curved fluidic channel; a first inlet channel and a second inlet channel, wherein each inlet channel is in fluidic communication with a proximal region of said curved fluidic channel; a first liquid flow device in fluid communication with said first inlet channel for directing a first liquid into said curved fluidic channel; a second liquid flow device in fluid communication with said second inlet channel for directing a magnetic microparticle suspension comprising a second liquid and magnetic microparticles into said curved fluidic channel, wherein said first inlet channel and said second inlet channel are configured such that the first liquid initially flows in a first laminar flow stream proximal to a first side of said curved fluidic channel, and such that the magnetic microparticle suspension initially flows in a second laminar flow stream proximal to a second side of said curved fluidic channel, wherein a length of said curved fluidic channel is selected to effect inversion of the first liquid and the second liquid via Dean flow, such that within a distal region of said curved fluidic channel, the second liquid flows in a third laminar flow stream proximal to said first side of said curved fluidic channel, and the first liquid flows in a fourth laminar flow stream proximal to said second side of said curved fluidic channel; one or more magnets positioned relative to said curved fluidic channel such that a magnetic field gradient is established across a width direction of said curved fluidic channel as Dean flow occurs along said curved fluidic channel exerting a force on the magnetic microparticles in the width direction such that the magnetic microparticles are retained proximal to said first side of said curved fluidic channel as the magnetic microparticles flow through said curved fluidic channel, and such that the magnetic microparticles reside predominantly within the third laminar flow stream in said distal region of said curved fluidic channel effecting solution exchange of the first liquid and the second liquid relative to the magnetic microparticles; and a first outlet channel and a second outlet channel, wherein each outlet channel is in fluidic communication with said distal region of said curved fluidic channel such that the third laminar flow is directed to said first outlet channel and the fourth laminar flow stream is directed to said second outlet channel.

In a particular case, at least one of the width, height and length of said curved fluidic channel and a flow rate of the magnetic microparticle suspension are selected such that, in the absence of said one or more magnets, inertial forces alone would be insufficient to retain the magnetic microparticles proximal to said first side of said curved fluidic channel as the magnetic microparticles flow through said curved fluidic channel.

In another case, said one or more magnets are positioned such that the magnetic field gradient is approximately uniform along at least a portion of said curved fluidic channel.

In yet another case, said one or more magnets is a cylindrical magnet surrounded at least in part by said curved fluidic channel.

In yet another case, said one or more magnets comprises a plurality of magnets arranged beyond an outer convex side of said curved fluidic channel.

In yet another case, said first side of said curved fluidic channel is an inner concave side of said curved fluidic channel, and wherein a magnetic force resulting from the magnetic field gradient is configured to retain the magnetic microparticles proximal to said inner concave side.

In yet another case, said first side of said curved fluidic channel is an outer convex side of said curved fluidic channel, and wherein a magnetic force resulting from the magnetic field gradient is configured to retain the magnetic microparticles proximal to said outer convex side.

In yet another case, magnetic properties of the magnetic microparticles and magnetic susceptibilities of the first liquid and the second liquid are selected such the magnetic force is attractive.

In yet another case, magnetic properties of the magnetic microparticles and magnetic susceptibilities of the first liquid and the second liquid are selected such the magnetic force is repulsive.

In another aspect, there is provided a method of performing solution exchange within a curved fluidic channel, the method comprising: directing, into a proximal region of the curved fluidic channel, a first liquid and a magnetic microparticle suspension, the magnetic microparticle suspension comprising a second liquid and magnetic microparticles, the first liquid and the magnetic microparticle suspension deliverable to the curved fluidic channel such that the first liquid initially flows in a first laminar flow stream proximal to a first side of the curved fluidic channel and such that the magnetic microparticle suspension initially flows in a second laminar flow stream proximal to a second side of the curved fluidic channel; while applying a magnetic field gradient along a width direction of the curved fluidic channel, flowing the first liquid and the magnetic microparticle suspension over a length of the curved fluidic channel suitable for effecting inversion of the first liquid and the second liquid via Dean flow, such that the second liquid forms a third laminar flow stream proximal to the first side of the curved fluidic channel, and the first liquid forms a fourth laminar flow stream proximal to said second side of the curved fluidic channel, wherein the magnetic field gradient is configured to exert a force on the magnetic microparticles in the width direction such that the magnetic microparticles are retained proximal to the first side of the curved fluidic channel as the magnetic microparticles flow through the curved fluidic channel, and such that the magnetic microparticles reside predominantly within the third laminar flow stream effecting solution exchange of the first liquid and the second liquid relative to the magnetic microparticles; and collecting the third laminar flow stream in a first outlet channel and the fourth laminar flow stream in a second outlet channel.

In a particular case, the width, height and length of the curved fluidic channel and a flow rate of the magnetic microparticle suspension are selected such that, in the absence of the magnetic field gradient, inertial forces alone would be insufficient to retain the magnetic microparticles proximal to the first side of the curved fluidic channel as the magnetic microparticles flow through the curved fluidic channel.

In another case, the length of the curved fluidic channel is selected to correspond to a half Dean cycle.

In yet another case, the magnetic microparticle suspension is flowed at a rate between 0.1 ml/min and 1 ml/min.

In yet another case, the magnetic microparticle suspension is flowed at a rate between 1 ml/min and 10 ml/min.

In yet another case, the curved fluidic channel is provided as an arc spanning less than 360 degrees.

In yet another case, the magnetic field gradient is uniform along the arc in a length direction.

In yet another case, the first side of the curved fluidic channel is an inner concave side of the curved fluidic channel, and wherein a magnetic force resulting from the magnetic field gradient is configured to retain the magnetic microparticles proximal to the inner concave side.

In yet another case, the first side of the curved fluidic channel is an outer convex side of the curved fluidic channel, and wherein a magnetic force resulting from the magnetic field gradient is configured to retain the magnetic microparticles proximal to the outer convex side.

In yet another case, magnetic properties of the magnetic microparticles and magnetic susceptibilities of the first liquid and the second liquid are selected such the magnetic force is attractive.

In yet another case, magnetic properties of the magnetic microparticles and magnetic susceptibilities of the first liquid and the second liquid are selected such the magnetic force is repulsive.

These and other aspects are contemplated and described herein. It will be appreciated that the foregoing summary sets out representative aspects of the assembly to assist skilled readers in understanding the following detailed description.

### DESCRIPTION OF THE DRAWINGS

A greater understanding of the embodiments will be had with reference to the Figures, in which:

FIGS. 1A-D show a number of different example configurations of a fluidic device for performing magnetophoretic solution exchange of particles in a curved fluidic channel.

FIG. 2 is a flow chart illustrating an example method of performing magnetophoretic solution exchange of particles in a curved fluidic channel and a subsequent magnetic particle based assay.

FIG. 3 illustrates example components of a system for performing magnetophoretic solution exchange of particles in a curved fluidic channel.

FIG. 4 is a photograph of an example microfluidic device for performing magnetophoretic solution exchange of 18.5 μm magnetic microparticles in a curved microfluidic channel. The device includes two inlets, two outlets, an R=1.185 cm curved microchannel and a permanent magnet.

FIGS. 5A and 5B show the inlet of the device and the gray intensity diagram of cross section AB (Inner Wall: IW; Outer Wall: OW). Gray color and intensity correspond to the darker Trypan blue dye in water stream.

FIGS. 5C and 5D show downstream pictures of the device close to outlets showing fluid switching and the gray intensity diagram of cross section AB, depicting that from 0-100 μm at the inner wall (i.e. inner outlet), water concentration was reasonably high. The curve then drops to a lower value that shows a darker region of Trypan blue.

FIG. 5E shows the initial 10% Trypan blue-water solution and collected samples from the inner and outer outlets. The inner outlet Trypan blue concentration was 0.8% (absorbance spectrophotometry table shown) which is comparable in color to the synthesized 0.8% Trypan blue solution.

FIG. 6 shows magnetophoretic concentration of magnetic particles in the initial sample (Q1) and collected outlets (Q3: IW outlet and Q4: OW outlet). Pictures of the microparticles in each sample is also shown. A 90% particle concentration efficiency and an 82% particle recovery rate was obtained.

FIGS. 7A and 7B show a microfluidic device consisting of a curved microchannel with a radius of curvature of R=1 cm and cross section area of w=300 μm by h=150 μm that was used for experimental investigation of average Dean velcosity (VDe). FIG. 7A shows water streams dyed with methylene blue and red food dye were introduced from the two inlets and their radial displacement was imaged. This is demonstrated schematically in FIG. 7B. Mcirochannels with four radii of curvatures (R=0.5, 1, 1.5 and 2 cm all with 150 μm×150 μm cross-section) and two additional cross-sectional dimensions (100 μm×150 μm and 300 μm×150 μm both with R=1 cm) were used in the studies.

FIGS. 8A and 8B show co-flow images of methylene blue (MB) and water at inlet flow rate of 0.6 mL min-1 (i.e., velocity of 0.22 m s-1) along the length of a 300 μm×150 μm curved microchannel with R=1 cm (a-1 to a-4) and intensity diagrams corresponding to assessment lines AB along the width of the channel at specific control points in each image (b-1 to b-4). (a-1 and b-1) show the beginning of the channel where the intensity diagram was similar to a step function and the fluids were completely separated, i.e., water at Inner Wall (IW) and MB at Outer Wall (OW). In (a-2 and b-2), MB and water started to displace laterally due to Dean flow vortices. In (a-3 and b-3), water was completely sandwiched in between MB layers, and the intensity diagram was almost uniform. In (a-4 and b-4), water and MB started to appear closer to the OW and IW, respectively, hence demonstrating switching in position compared to their initial conditions.

FIGS. 9A-E show Switching Index (SI) diagrams along the length of the channel at various inlet axial velocities, Vx, of methylene blue and water that were co-injected into a device with R=2 cm and cross section area of 150 μm×150 μm. SI decreases along the channel as the two solutions form counter-rotating vortices and increases when they start separating from each other into distinct phases again downstream the channel. The first peak in the SI plot indicates the exact location of the first switch in position (Ls) of methylene blue and water solutions (i.e., 180° recirculation). At higher axial velocities, a second switch corresponding to a full 360° recirculation of fluids can be clearly seen.

FIGS. 10A-C plot Dean vortex shape approximation and calculated average Dean velocities in a curved microchannel with R=2 cm and cross section area of 150 μm×150 μm. Dean vortices were assumed to follow (a) an elliptical path for δ<0.008 (δ=D/2R) and (b) a half-elliptical half-circular path for δ>0.00825. (c) The switching lengths obtained experimentally and the approximated average lateral travel distances were used to calculate the average Dean velocities (VDe) at different axial velocities in the abovementioned device. The solid line in (c) shows a power function (VDe=aDeb) fitted over the experimental data points with constants a=0.072 and b=2 (R2=0.98). The dashed line in (c) shows the Ookawara's31 equation for Dean velocity (mm s-1) with a=0.18 and b=1.63 (R2=0.71).

FIGS. 11A and 11B show the effect of radius of curvature of the channel (R=0.5-2 cm) on Dean velocity shown (a) at various axial velocities and (b) using the non-dimensional Dean number for devices with 150 μm×150 μm cross section. The Dean velocity decreases as the radius of curvature increases at each inlet velocity. Increasing the Dean number (via axial velocity) for each device resulted in an increase in Dean velocity. A power function (VDe=aDeb) fitted over the experimental results in (b) provided the constants of a=0.090 and b=1.95 with R2=0.98. Numerical results based on the model (a=0.096 and b=1.92) and Ookawara's model (a=0.18 and b=1.63) are also shown with a solid and a dashed line, respectively.

FIGS. 12A and 12B plot the effect of channel hydraulic diameter (D) on average Dean Velocity (VDe) using numerical modeling of a curved microchannel with R=0.5 cm radius of curvature shown (in FIG. 12A) at various axial velocities and (FIG. 12B) using the non-dimensional Dean number. At each inlet velocity, increasing the hydraulic diameter resulted in higher VDe. But when plotted VDe as a function of De in FIG. 12B, it is observed that the hydraulic diameter inversely affects the VDe when Dean number is kept constant. Single a and b constants could not be found to predict VDe with a single power function (VDe=aDeb).

FIGS. 13A-F show the effect of channel width (w) and height (h) on Dean velocity for curved microchannels with R=0.5 cm. FIGS. 13A-C show the effect of height at fixed channel widths while FIGS. 13D-F show the effect of width at fixed channel heights on Dean velocity.

FIGS. 14A and 14B plot the effect of fluid kinematic viscosity on Dean velocity in a 150 μm×150 μm curved microchannel with R=0.5 cm shown in FIG. 14A at various axial velocities and in FIG. 14B using the non-dimensional Dean number. Increasing the viscosity while axial velocity is constant caused a reduction in VDe. However, when Dean number was kept constant, viscosity directly affected the VDe. Single a and b constants could not be found to predict VDe with a single power function (VDe=aDeb).

FIG. 15 plots Dean velocity against

$$( \frac{v}{s} ) {De}^{1.63}$$

based on all numerical results obtained in this study. A linear function could be fitted over the data points (R2=0.9983) with a=0.031 as the constant of linearity. The inset figure shows the experimental Dean velocities from single experiments in two devices with cross sectional dimensions of 100 μm×150 μm and 300 μm×150 μm (cross data points) that follow the numerically-determined fit very well.

### DETAILED DESCRIPTION

Various embodiments and aspects of the disclosure will be described with reference to details discussed below. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosure.

As used herein, the terms “comprises” and “comprising” are to be construed as being inclusive and open ended, and not exclusive. Specifically, when used in the specification and claims, the terms “comprises” and “comprising” and variations thereof mean the specified features, steps or components are included. These terms are not to be interpreted to exclude the presence of other features, steps or components.

As used herein, the term “exemplary” means “serving as an example, instance, or illustration,” and should not be construed as preferred or advantageous over other configurations disclosed herein.

As used herein, the terms “about” and “approximately” are meant to cover variations that may exist in the upper and lower limits of the ranges of values, such as variations in properties, parameters, and dimensions. Unless otherwise specified, the terms “about” and “approximately” mean plus or minus 25 percent or less.

It is to be understood that unless otherwise specified, any specified range or group is as a shorthand way of referring to each and every member of a range or group individually, as well as each and every possible sub-range or sub-group encompassed therein and similarly with respect to any sub-ranges or sub-groups therein. Unless otherwise specified, the present disclosure relates to and explicitly incorporates each and every specific member and combination of sub-ranges or sub-groups.

As used herein, the term “on the order of”, when used in conjunction with a quantity or parameter, refers to a range spanning approximately one tenth to ten times the stated quantity or parameter.

Unless defined otherwise, all technical and scientific terms used herein are intended to have the same meaning as commonly understood to one of ordinary skill in the art. Unless otherwise indicated, such as through context, as used herein, the following terms are intended to have the following meanings:

As used herein, the phrase “microfluidic channel” refers to a channel having at least one cross-sectional dimension that is less than one millimeter.

The present disclosure provides systems and methods that enable the magnetophoretic separation of magnetic particles using Dean flow in curved fluidic channels. Many of the embodiments disclosed herein have been developed to overcome the limitations of curved microchannel inertial separation devices known in the art. In particular, many of the example embodiments of the present disclosure are capable of achieving the separation of magnetic particles, with solution exchange, within fluidic channels having a reduced length relative to those known in existing curved microchannel inertial separation devices, and/or at flow rates higher than those of existing curved microchannel inertial separation devices.

As described above, some of the curved microchannel inertial separation devices are known in the art employ a full Dean cycle to achieve inertial-based separation of particles in the presence of buffer exchange, in which the initial separate laminar flow streams of two injected fluids (a sample stream and a buffer stream) are reversed, and then reversed again. The sample stream (containing particles to be separated) is injected near the outer wall of the microchannel, and a sheath/buffer stream is injected near the inner wall of the microchannel. Drag forces associated with Dean flow vortices cause lighter particles injected into the stream near the outer wall to migrate, during the first half Dean cycle, toward the inner wall under the lateral Dean drag forces, and then to migrate, during the second half Dean cycle, in the opposite direction back to the outer wall, again under lateral Dean drag forces. Larger particles also injected into the stream near the outer wall also migrate, during the first half Dean cycle, toward the inner wall under the inertial and drag forces. However, these larger particles become subject to inertial forces near the inner wall, and are retained near the inner wall during the second half Dean cycle, as the inertial forces dominate over the lateral Dean drag forces for these larger particles. At the output location, corresponding to a full Dean cycle, the smaller particles residing near the outer wall are separated from the larger particles residing near the inner wall. Furthermore, since the laminar flow stream of the sheath/buffer stream is doubly inverted in position and resides near the inner wall at the output of the microchannel, solution exchange occurs for the larger microparticles, which are collected at the output in the sheath/buffer.

Unfortunately, such inertial microfluidic devices are known to suffer from very low sample flow rates that are typically in the range of 10-100 μL/min. At such low flow rates, the processing of samples having volumes of several milliliters can require processing times of hours, rendering them unsuitable for many applications. Furthermore, such devices are typically large, employing long microchannel lengths on the order of 10-100 cm, due to the need for long interaction lengths, and the channel length required to achieve particle focusing and a full Dean cycle at low flow rates above. Moreover, conventional curved microchannel inertial separation devices require a spiral configuration with multiple turns (an angular span of >360°) due to the microchannel length required for inertial focusing and separation as well as a complete Dean cycle. Such configuration necessitates out-of-plane connections to the input and the output of the curved microchannel. Yet another disadvantage of curved microchannel inertial separation devices is that such devices are inherently unable to perform separations among particles having a common or similar size.

While Dutz et al. has disclosed the use of a magnetic field gradient to aid in the separation of magnetic microparticles in a curved microchannel separation device, the teachings of Dutz et al. lead to device implementations that suffer from the same drawbacks as the non-magnetic devices described above. This appears to be a result of the manner in which the magnetic field gradient of Dutz et al. is employed to supplement inertial forces. Dutz et al. employs magnetic field gradient magnitudes that are insufficient to produce magnetophoretic separation of magnetic microparticles at flow rates above the very low flow rate of approximately 20 μL/min. Above this low flow rate, inertial forces become dominant over the magnetophoretic forces. This low limit appears to be due to the approach and design philosophy of Dutz et al. in which magnetic forces are applied that have a magnitude suitable for counteracting inertial forces within the flow rates typically employed in curved microchannel separation devices. Accordingly, even at relatively low flow rates in the 40-80 μL/min range, the device of Dutz et al. functions effectively as an inertial separation device.

Another significant limitation of the Dutz device (and other spiral-based separation devices known in the art) is the inability to house a magnet within the central region, limiting the magnet placement to the outer device region.

It is also noted that the teachings of Dutz et al. are limited to spatially separating magnetic microparticles with a sample suspension that is flowed through a microchannel, absent of any sheath or buffer solution. It is therefore unclear, based on the limited teachings of Dutz et al., how the use of the magnetic forces could be applied to device configurations involving Dean flow mediated solution exchange.

The present inventors have found that the aforementioned shortcomings of known curved microchannel inertial separation devices can be addressed by employing a device configuration in which magnetophoretic separation of magnetic microparticles and solution exchange are achieved over a half Dean cycle. As described in detail below, this can be achieved by the application of a magnetic field gradient that is sufficiently strong to produce a suitable magnetophoretic force to retain and separate the magnetic particles, even at high flow rates in excess of 1 ml/min. The use of magnetophoretic forces for the separation of magnetic microparticles effectively decouples the dominant lateral applied force (the magnetic force) from the channel geometry and flow conditions, thereby providing a robust force that can be employed to achieve separation over a wide range of channel geometries and flow rates. Moreover, the present example embodiments enable separation of magnetic and non-magnetic particles having common or similar sizes, in contrast to conventional curved microchannel inertial separation devices. As described below, the magnetophoretic separation systems and methods described herein may be employed to perform separations of magnetic microparticles that are configured to selectively adhere or bind specific analyte cells or molecules. In some example implementations, the example embodiments described herein may be employed as a portable micro-centrifuge for sample preparation for use in point-of-care assay devices.

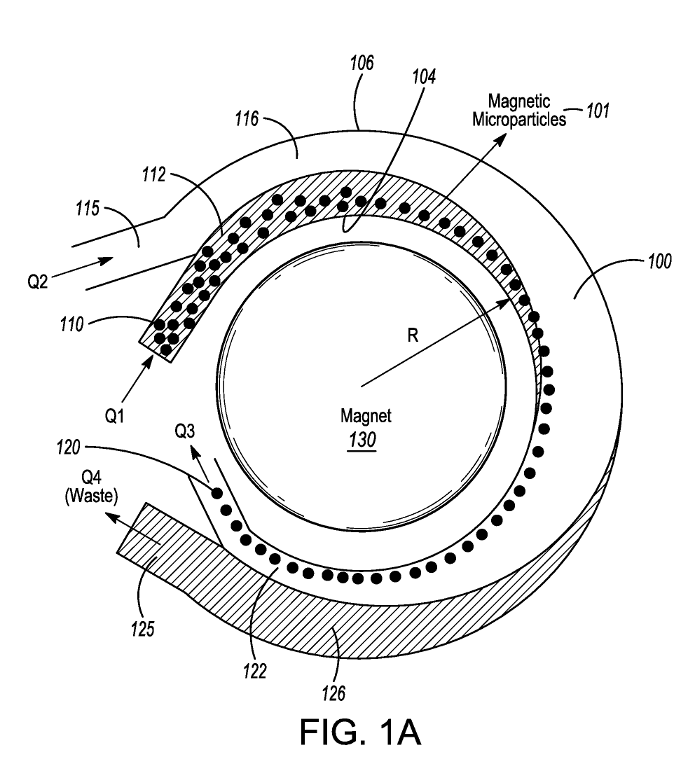

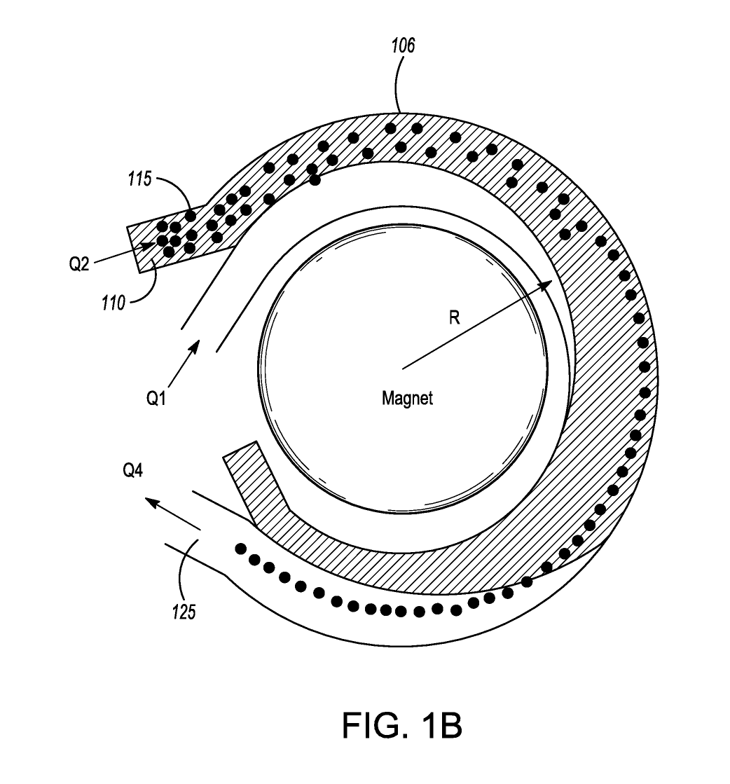

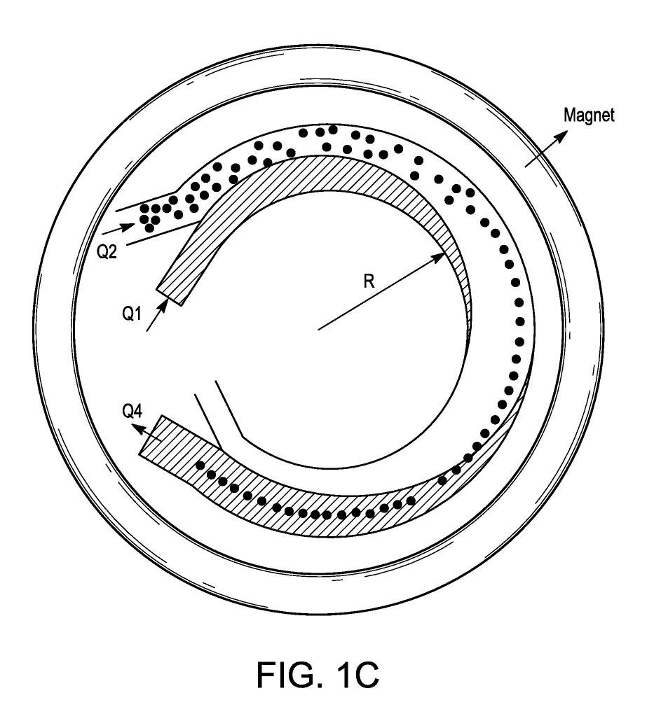

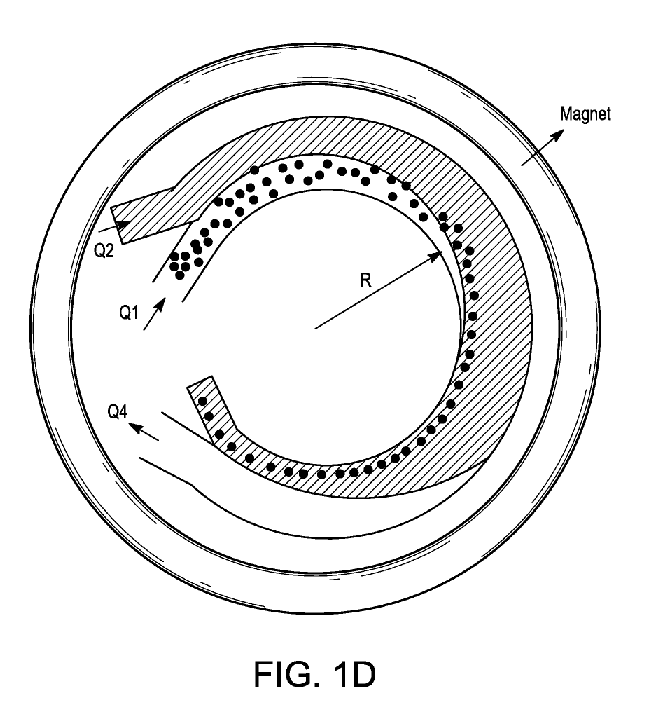

Referring now to FIG. 1A, an example embodiment of a fluidic device for performing magnetophoretic separation and solution exchange in curved fluidic channel is illustrated. The device employs a curved fluidic channel 100, which may be a microfluidic channel, or may have macrofluidic channel dimensions exceeding those of microfluidic channels. Two inlet channels, 110 and 115, respectively, are in fluid communication with a proximal region of the curved fluidic channel 100, for introducing fluids into the curved fluidic channel 100.

The first inlet channel 110 is in fluid communication with a first flow device (or flow mechanism, not shown) for the delivery of a magnetic microparticle suspension that includes at least a first liquid and magnetic microparticles 101. The magnetic microparticle suspension flows in a first laminar flow stream 112 proximal to the inner concave side 104 of the curved fluidic channel 100. The second inlet channel 115 is in fluid communication with a second flow device (or flow mechanism, not shown) for the delivery of a second liquid, which may be a sheath liquid or a buffer liquid. The second liquid flows in a second laminar flow stream 116 proximal to the outer convex side 106 of the curved fluidic channel 100, and also flows adjacent to the first laminar flow stream 112.

The dimensions (cross-sectional dimensions and length) of the curved fluidic channel 100 is selected to effect inversion of the first liquid and the second liquid via Dean flow (i.e. configured to produce solution exchange over the length of the curved fluidic channel 100; configured to achieve a half Dean cycle over the channel length), such that within a distal region of the curved microfluidic channel 100, the second liquid flows in a third laminar flow stream 122 proximal to the inner concave side of the curved fluidic channel 100, and the first liquid flows in a fourth laminar flow stream 126 proximal to the outer convex side 126 of the curved fluidic channel 100.

The example device also includes a magnet 130 positioned to generate a magnetic field gradient within the curved fluidic channel 100. In the example embodiment shown in FIG. 1A, the magnet 130 resides adjacent to the inner concave side 104 of the curved fluidic channel 100, such that the magnet 130 is partially surrounded by the curved fluidic channel 100. The magnet 130 generates a magnetic field gradient across at least a width direction of the curved fluidic channel 100 (and optionally a height direction, if the magnet is not centered on or perpendicular to the plane of the curved fluidic channel) as Dean flow occurs along the curved fluidic channel 100, thereby exerting a force on the magnetic microparticles 101 in the width and height direction such that the magnetic microparticles are retained proximal to the concave inner side of the curved fluidic channel 100 as the magnetic microparticles 101 flow through the curved fluidic channel 100. The magnetic microparticles 101 thereby reside predominantly within the third laminar flow stream 122 in the distal region of the curved fluidic channel 100, thereby effecting solution exchange of the first liquid and the second liquid relative to the magnetic microparticles 101.

Two outlet channels, 120 and 125, respectively, are in fluid communication with a distal region of the curved fluidic channel 100, for extracting or collecting fluids from the curved fluidic channel 100, such that the third laminar flow is directed to the first outlet channel 120 and the fourth laminar flow stream 125 is directed to the second outlet channel 125. The magnetic microparticles, suspended in the second liquid via solution exchange and magnetophoretic separation, are collected within the second liquid through the first outlet channel 120, optionally for further processing, as described below. The residual first liquid is directed to the second outlet channel 125. The residual first liquid may, for example, be directed to a waste chamber, or sent for further processing.

As used herein, Q1 refers to a flow rate in the first inlet channel 110, Q2 refer a flow rate in the second inlet channel 115, Q3 refers to a flow rate in the first outlet channel 120, and Q4 refers to a flow rate in the second outlet channel 125.

It is noted that the solution exchange will generally be imperfect, such that a small amount of the first liquid may be present in the third laminar flow stream. Furthermore, the efficiency of separation of the magnetic microparticles (i.e. magnetic microparticle recovery) may not be 100%, such that some magnetic microparticles may reside in the fourth laminar flow stream 126. For example, the recovery rate may be defined as the number of magnetic particles in both outlet channels divided by the number of magnetic particles injected into the curved fluidic channel, and the inventors have experimentally observed recovery rates in excess of 94%. Furthermore, the separation efficiency may be defined as the number of magnetic particles in outlet channel in which the magnetic particles are collected in the buffer liquid, divided by the number of magnetic particles collected in both outlet channels, and the inventors have experimentally observed separation efficiencies in excess of 91%.

As noted above, the channel dimensions and channel length are selected such that inversion (switching) of the fluid streams occurs between the proximal and distal regions of the curved fluidic channel 100 (i.e. such that the region between the proximal and distal ends of the channel corresponds approximately to a half Dean cycle). Parameters that affect the Dean flow and are considered in designing the curved channels are fluids densities and viscosities, fluids flow rate, and channel dimensions such as width and height of the curved channel and its radius of curvature and length. These parameters can be determined, for example, based on simulations or based on experimental studies. For example, design parameters for achieving a desired Dean flow configuration can be obtained according to the design methodologies shown in Example 2 of the present disclosure. In another example implementation, channel parameters can be selected by fabricating different devices with variations in channel parameters, and experimentally determining channel parameters that achieve suitable Dean flow characteristics to obtain the desired solution exchange (half Dean cycle).

The example embodiment shown in FIG. 1A is illustrative of a non-limiting implementation of a fluidic device for performing magnetophoretic separation and solution exchange in curved fluidic channel. It will be understood that the specific arrangement of inlet and outlet ports with regard to the magnetic microparticle suspension and the second liquid is only one of several possible configurations.

An alternative example configuration is shown in FIG. 1B, in which the magnetic microparticle suspension is introduced into inlet channel 115 and the second liquid (e.g. a sheath/buffer liquid) is introduced into inlet channel 110. Unlike the embodiment shown in FIG. 1A, the magnetic force is repulsive, such that the magnetic microparticles are retained proximal to the outer convex side 106 of the curved fluidic channel 100. As in FIG. 1A, however, the initial laminar streams are inverted due to the length of the curved fluidic channel 100 being approximately equal to the distance associated with a half Dean cycle. The magnetic microparticles are thus separated from the first liquid in which they were initially suspended via solution exchange, such that in the distal region of the curved fluidic channel, the magnetic microparticles are suspended in the second liquid and are extracted via the second outlet channel 125.

As explained above, the direction of the magnetic force is repulsive in FIG. 1B, as opposed to the attractive magnetic force shown in FIG. 1A. The direction of the magnetic force is dependent on a number of factors, any one or more of which can be selected in order to achieve a desired magnetic force direction (attractive or repulsive). Non-limiting examples of properties that affect the direction of the applied force include the type of magnetic microparticle (e.g. ferromagnetic vs. paramagnetic) and the relative magnetic susceptibility of the solutions in which the magnetic microparticles are suspended. Indeed, the applied magnetic force can be expressed with the following equation:

$$F = \frac{V Δχ}{{μ}_{0}} ( B \cdot ∇ ) B$$

where V is the volume of the particle (m³), Δχ is the difference in magnetic susceptibilities between the particle and the surrounding medium (dimensionless and can be positive or negative dependent on the magnitudes of particle and fluid susceptibility), μ₀ is the permeability of vacuum, and B is the applied magnetic field (T).

Accordingly, if the magnet is positioned internally, such that is surrounded at least in part by the curved fluidic channel, then the magnetic microparticles are attracted inwards if Ax is positive (as in FIG. 1A), and the magnetic microparticles are repelled outwards if Ax is negative (as in FIG. 1B). For example, paramagnetic microparticles, which are magnetized in the presence of a magnetic field, are attracted towards higher magnetic field gradient, while diamagnetic particles, which are also magnetized in presence of a magnetic field, are repelled towards a lower magnetic field gradient. Furthermore, is noted that the properties of the sample liquid (first liquid) or the sheath/buffer liquid (second liquid) may be selected to have a suitable composition for varying the magnetic behaviour of particles via magnetic susceptibility differences between the magnetic microparticles and the liquid (for example, magnetic microparticles can exhibit paramagnetic behaviour in some solutions, while exhibiting diamagnetic behaviour in another solution).

The orientation of the magnet is another parameter than can affect the direction of the applied force. Accordingly, if the magnet (or a series of magnets) is located beyond the outer convex side of the curved fluidic channel, then the direction of the magnetic field gradient will be such that the magnetic microparticles are attracted outwards when Δχ is positive, and repelled inwards when Δχ is negative. These two example cases are illustrated in FIGS. 1C and 1D, respectively.

Unlike the curved microchannel separation devices known in the art and described above, magnetophoretic devices with curved fluidic channels according to embodiments of the present disclosure may be configured having a channel length and a magnetic microparticle suspension flow rate such that, in the absence of the magnetic force (the magnetophoretic force), inertial forces alone would be insufficient to retain the magnetic microparticles proximal to the side of the curved fluidic channel as the magnetic microparticles flow through the curved fluidic channel. For example, FIG. 1A illustrates an example embodiment in which the curved fluidic channel extends over an arc having an angular span that is less than a full turn (full rotation; 360 degrees), enabling particle separation and solution exchange to occur over a much shorter length than the curved microchannel separation devices known in the art that require a spiral configuration in order to achieve inertial separation. Such an embodiment also allows fluid interfacing in an in-plane configuration with the inlet and outlet channels, without requiring out-of-plane interfacing through a via or port.

However, in other example embodiments of the present disclosure, the curved fluidic channel may extend over more than a single turn, and may be configured in a spiral configuration. It is also noted that the curved fluidic channel, and/or the one or more magnets employed to provide the magnetic field gradient, may have a circular (e.g. cylindrical) shape or a non-circular shape, such as an elliptical shape. In another example embodiment, one or more magnets may be ring-shaped.

In some example embodiments, one or more magnets are located adjacent to the curved fluidic channel such that a uniform magnetic field gradient is generated along the length of the fluidic channel. However, other example embodiments may be realized in which the magnetic field gradient is non-uniform over the channel length (for example, a non-uniform magnetic field gradient would be formed in an elliptically shaped channel by a circular magnet). In some example embodiments, the magnetic field gradient may be uniform over at least a portion of the fluidic channel length.

Although FIG. 1A shows a configuration in which a single permanent magnet is employed to generate the magnetic field gradient for magnetophoretic particle transport, it will be understood that a wide variety of magnet configurations may be employed without departing from the intended scope of the present disclosure. For example, two or more permanent magnets may be employed to generate the magnetic field gradient. In other example embodiments, one or more magnets may be an electromagnet.

Although various example embodiments of the present disclosure involve the magnetophoretic separation of magnetic microparticles from a first liquid into a second liquid via Dean flow mediated solution exchange, other implementations of the present example embodiments may involve the selectively separation or sorting of magnetic microparticles from non-magnetic microparticles with same or different sizes. It is further noted that although many of the example embodiments of the present disclosure show the magnetic microparticles as being injected into the curved fluidic channel in the form of a sample laminar flow stream adjacent to a sheath/buffer laminar flow stream, it will be understood that the magnetic microparticles can be added to any of the inlet streams. For example, in one example implementation, magnetic microparticles of different magnetism type (e.g. ferromagnetic and paramagnetic) may be respectively added through the two laminar flow streams, such that the different magnetic microparticles experience magnetophoretic forces in different lateral directions, facilitating both solution exchange for both types of magnetic microparticles.

It will be understood that the dimensions of the curved fluidic channel, including the width and height, the length, and the radius of curvature, can take on a wide range of values according to different implementations of the example embodiments disclosed herein. For example, in some example embodiments, the channel width and height can range from approximately 3 microns to approximately 3 millimeters, and the channel length can range from approximately 100 micrometers to approximately 10 cm (or more), and the radius of curvature can range between approximately 100 micrometers to 10 centimeters (or more).

In one example implementation, the parameters above can be selected for sample and buffer fluids with specific densities and viscosities, and for the desired operating flow rates, based on the following semi-empirical that has been derived numerically and experimentally:

$${V}_{De} = 0.031 ( \frac{v}{s} ) {( \frac{VD}{v} \sqrt{\frac{D}{2 R}} )}^{1.63}$$

where V is the fluid axial velocity in the curved channel, V_{De} is the average Dean lateral flow velocity, ν is fluid kinematic viscosity (=viscosity/density), and s, D, and R are the largest cross section dimension, hydraulic diameter and radius of curvature of the curve channel.

The flow rate of the magnetic microparticle suspension may also be selected from a wide range of possible rates, ranging from approximately 10 μL/min to approximately 50 ml/min. In some example embodiments, the flow rate may range between 1 to 2 ml/min, 1 to 3 ml/min, 1 to 5 ml/min, 1 to 10 ml/min, 2 to 3 ml/min, 2 to 5 ml/min, 2 to 10 ml/min, and 5 to 10 ml/min. Moreover, the present inventors have found that for given channel configuration, magnetic microparticle separation with solution exchange is feasible over a wide range of flow rates. For example, in the case of the example device described below, separation and solution exchange were observed for flow rates ranging from 1-3 ml/min.

As noted above, the magnetic field gradient is also selected to be sufficiently high to achieve magnetophoretic separation within one half Dean cycle. It will be understood that the suitable magnetic field gradient magnitude and direction will be dependent on a number of different parameters of the device, such as the flow rate and the dimensions of the curved fluidic channel as well as fluid magnetic susceptibility with respect to that of particles. Examples of suitable magnetic field gradient magnitudes include 0.1-10 T/m.

The magnetic microparticles may have a wide range of sizes, since magnetic forces, as opposed to inertial forces, are employed to apply the lateral forces that lead to particle separation. Non-limiting examples of size ranges include 0.1-1 μm, 1-10 μm, 10-100 μm and 1-100 μm. The magnetic particles may be ferromagnetic particles such as magnetite (Fe3O4; iron oxide), Fe, Fe2O3 (magnetic phases), Ni, Co, Gd, Dy, Fe3C, FeBe5, Cu2MnAl, Cu2MnIn, Au2MnAl, Fe2B, MnAs, MnBi, MnB, CrTe, CrO2, CrBr3, EuO, and GdCl3. In some example embodiments, magnetic particles may be provided in a core-shell configuration, for example, in which a magnetic core is capped by a non-magnetic shell or vice versa (e.g. carboxylated, Amine-modified, and polystyrene coated or cored magnetic particles). Other examples of magnetic particles include paramagnetic, superparamagnetic particles, and/or diamagnetic particles.

The magnetic particles may be modified (e.g. functionalized) to bind with one or more analyte molecules or particles, e.g. through a ligand-receptor or other molecular interaction. For example, the magnetic particles may include a molecular recognition element such as, but not limited to, ligands, proteins, antibodies, aptamers, nucleic acids, and nucleic acid analogs.

Although many of the example embodiments of the present disclosure employ a pair of inlet channels and a pair of outlet channels, it is to be understood that this device configuration is intended to be non-limiting, and that in general, magnetophoretic devices according to the present disclosure may be configured with two or more inlet channels, and/or two or more outlet channels.

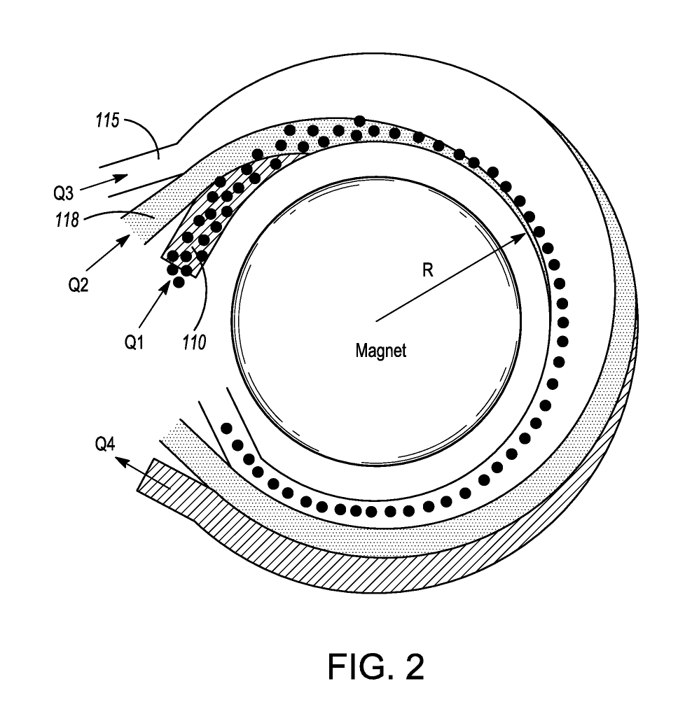

For example, FIG. 2, illustrates an example device that includes three inlet channels and three outlet channels, in which the inner wall inlet channel 110 is employed for introducing the magnetic particle suspension liquid 1, the central inlet channel 118 is employed for introducing a buffer liquid for coating magnetic particles with specific analytes or materials (e.g. antibodies or oil), and the outer wall inlet 115 is employed for introducing a sheath/buffer liquid for washing the magnetic particles. The magnetophoretic forces maintain the magnetic particles at the inner wall of the curved channel while the Dean flow transports the coating buffer liquid over the particles for coating them with a specific target analyte. Continuation of the Dean flow results in transport of the sheath liquid onto the magnetic particles upon completion of the Dean half-cycle and washing and extraction of magnetic particles from the curved channel in the sheath liquid.

Although FIG. 2 illustrates an example embodiment in which three outlet channels are present, it will be understood that other alternative example embodiments may have a different number of outlet channels. For example, one example implementation may include two outlet channels, where one outlet channel is employed to separate the magnetic-microparticle-buffer stream from the other streams together (e.g. source sample+medium coater).

Similarly, FIG. 2B illustrates an example embodiment in which three outlets are included. In such an example embodiment, the three liquids can be collected separately for possible post washing applications.

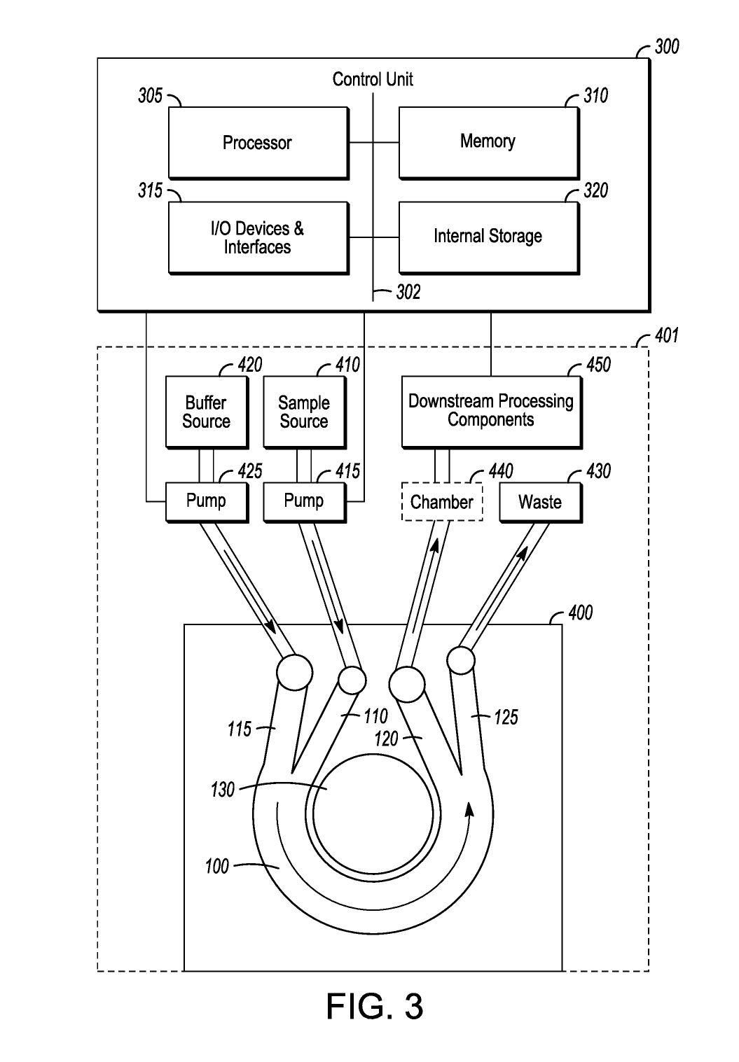

Referring to FIG. 3, an example fluidic system is illustrated for performing magnetophoretic separation and solution exchange. The figure shows an example magnetophoretic separation device 400, configured in the non-limiting example embodiment according to the example configuration shown in FIG. 1A. The example fluidic device 400 includes a curved fluidic channel 100 that partially surrounds a magnet 130. A sample, containing magnetic microparticles, is delivered from a sample source 410 to the first inlet channel 110 via a first liquid flow device 415 (for example, a pump or a siphon), and the sheath/buffer liquid delivered from a sheath/buffer source 420 to the second inlet channel 115 via a second liquid flow device 425 (for example, a pump or a siphon). The processed magnetic microparticle stream, after solution exchange via Dean flow, is collected from the first outlet channel 120, and the residual sample liquid is collected from the second outlet channel 125. In the example embodiment shown in the figure, the residual sample liquid is transferred to a waste chamber 430. The collected magnetic microparticles may be collected in a collection chamber 440 and/or may be transferred to additional fluidic components or devices for further processing, as shown at 450. Examples of additional fluidic components include, but are not limited to: an elution chamber with magnetic or filtration separation of the magnetic microparticles from analyte eluted therefrom, lysis chambers/devices with optional lysis reagents, and one or more functional assay components or devices, such as chambers and detection devices (e.g. an optical detector and optional optical source) for performing immunoassays and/or molecular assays such as polymerase chain reaction.

The liquid flow devices 415 and 425 may be controlled by control unit 300, for example, for adjusting the flow rate of the dispensed liquids. The control unit 300 may additionally or alternatively be interfaced one or more of the downstream processing devices, for example, for automating one or more assay steps. As shown in the figure, example control unit 300 includes one or more processors 305 (for example, a CPU/microprocessor), a bus 302, memory 310, which may include random access memory (RAM) and/or read only memory (ROM), one or more input/output devices and/or interfaces 315 (e.g. a user input device, such as a keyboard, a keypad, a mouse), and optionally one or more internal storage devices 320 (e.g. a hard disk drive, compact disk drive or internal flash memory), and a power supply (not shown). The control unit 300 may include additional components, such as one or more communications interfaces and external storage.

Although only one of each component within control unit 300 is illustrated in FIG. 3, more than one of some components can be included in control unit 300. For example, although bus 302 is depicted as a single connection between all of the components, it will be appreciated that the bus 202 may represent one or more circuits, devices or communication channels which link two or more of the components. For example, in personal computers, the bus 202 often includes or is a motherboard.

In some example embodiments, one or more of the sources (410 and 420), liquid flow devices (415 and 415), waste chamber 430, collection chamber 440, and/or downstream processing components 450, may be implemented on an integrated common device that includes the magnetophoretic separation device 400 (e.g. as shown at 401 in FIG. 3), or alternatively as external devices.

In one embodiment, the control unit 300 includes a general purpose computer or any other hardware equivalents that is programmed to perform the methods disclosed herein. The control unit 300 may also be implemented as one or more physical devices that are coupled to processor 305 through one of more communications channels or interfaces. For example, components of control unit 300 can be implemented using application specific integrated circuits (ASICs). Alternatively, the control unit 300 can be implemented as a combination of hardware and software, where the software is loaded into the processor from the memory or over a network connection. The control unit 300 may be programmed with a set of instructions which when executed in the processor 305 causes the system to perform one or more methods described in the disclosure. The control unit 300 may include many more or less components than those shown.

A computer readable medium can be used to store software and data which when executed by a data processing system causes the system to perform various methods. The executable software and data can be stored in various places including for example ROM, volatile RAM, non-volatile memory and/or cache. Portions of this software and/or data can be stored in any one of these storage devices. In general, a machine-readable medium includes any mechanism that provides (i.e., stores and/or transmits) information in a form accessible by a machine (e.g., a computer, network device, personal digital assistant, manufacturing tool, any device with a set of one or more processors, etc.).

Examples of computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., compact discs (CDs), digital versatile disks (DVDs), etc.), among others. The instructions can be embodied in digital and analog communication links for electrical, optical, acoustical or other forms of propagated signals, such as carrier waves, infrared signals, digital signals, and the like.

The following examples are presented to enable those skilled in the art to understand and to practice embodiments of the present disclosure. They should not be considered as a limitation on the scope of the disclosure, but merely as being illustrative and representative thereof.

### Example 1: Experimental Demonstration of Fluidic Device Employing Curved Channel and Magnetic Field Gradient to Achieve Magnetophoretic Separation and Solution Exchange

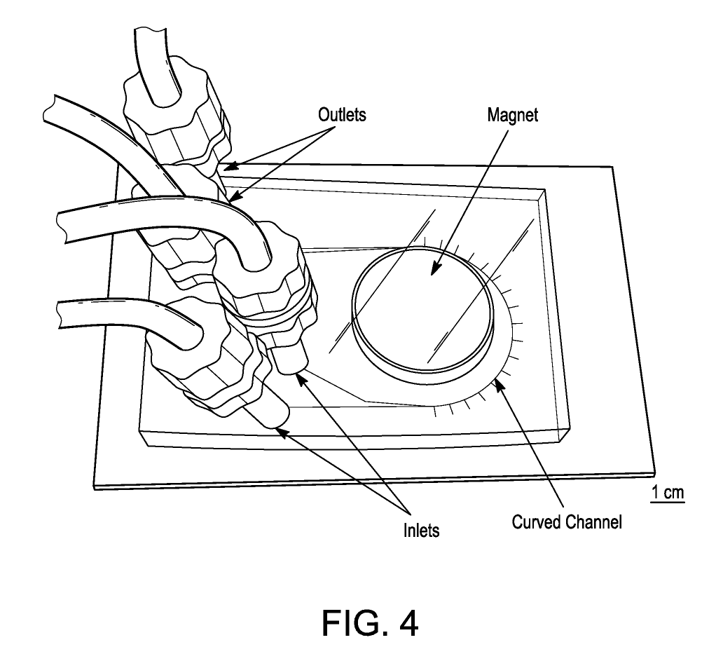

FIG. 4 shows an experimental implementation of an example device for performing magnetophoretic solution exchange in a curved microfluidic channel, in which magnetic focusing of magnetic particles at the inner wall of a curved microchannel and secondary Dean flow-based exchange of their fluid was employed to achieve solution exchange. A circular permanent magnet was placed in the middle of the curve-channel to focus the microparticles close to its inner wall. The microchannel radius of curvature, width and height were 1.185 cm, 300 μm and 60 μm, respectively. DI water and 18.5 μm-diameter magnetic microparticles suspended in 10% Trypan Blue (TB) in water were co-flown via the inner and outer inlets into the device, respectively. The quality of fluid recirculation and magnetic particle focusing was investigated by on-chip microscopy and off-chip spectrophotometry and hemocytometry of inlet and outlet samples.

The following semi-empirical Dean velocity equation (described in detail in Example 2 below) was employed to calculate the Q≈1 ml/min flow rate at which a half-recirculation of inlet fluids could be theoretically achieved at outlets:

$${V}_{De} = 0.031 \frac{v}{s} {De}^{1.63} where De = \frac{VD}{v} \sqrt{\frac{D}{2 R}} , {V}_{De} ,$$

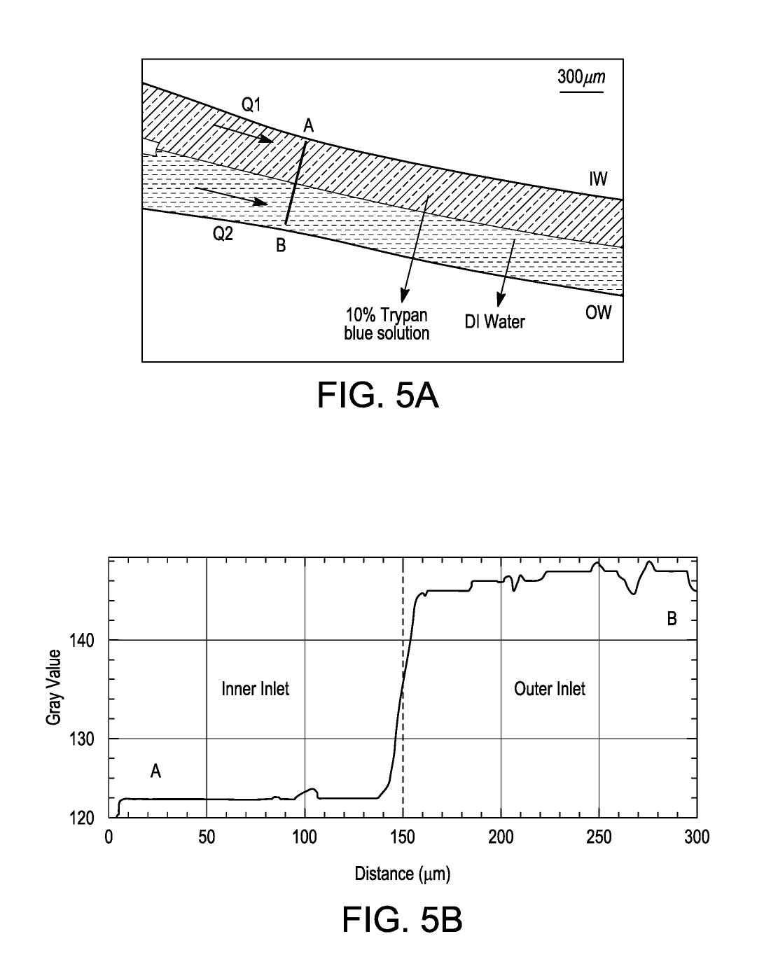

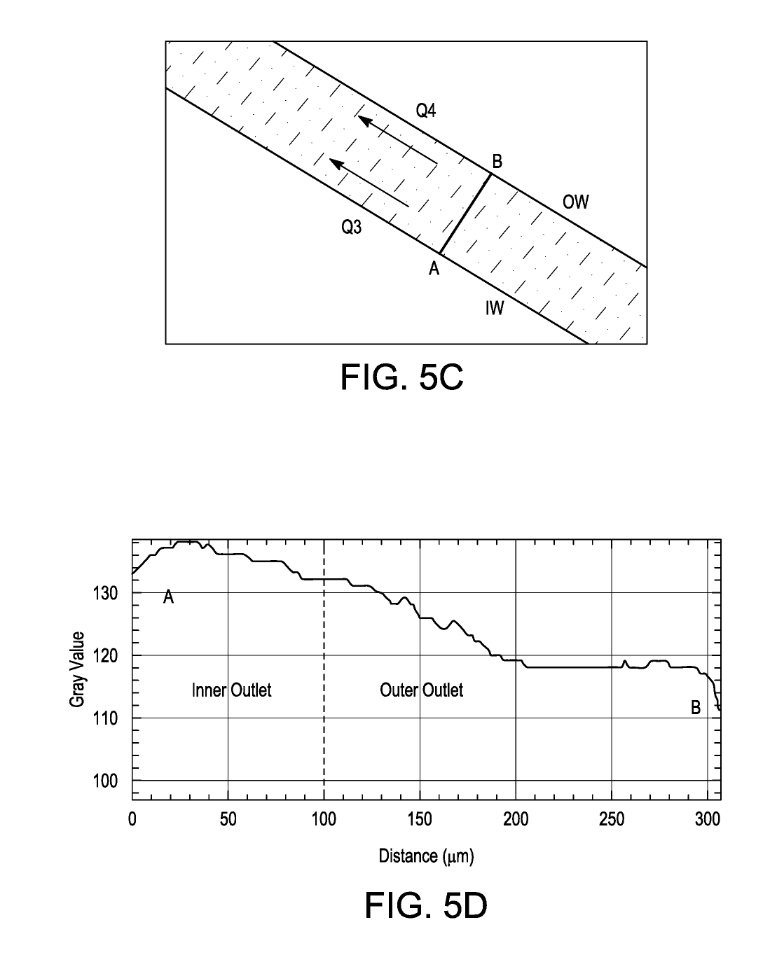

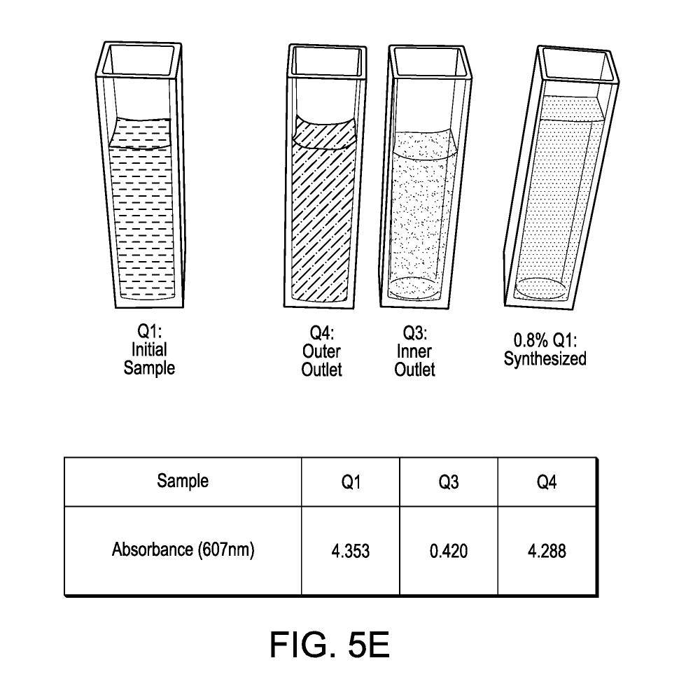

υ and s are the Dean number, Dean velocity, kinematic viscosity and larger dimension of the channel, respectively. FIGS. 5A-D show the switching process by depicting the inlet and outlet regions along with the gray intensity values along the corresponding cross sections AB. A complete radial switch of the buffer and sample solutions is demonstrated. The purity of solution exchange, measured by examining the spectrophotometric concentration of TB in collected samples at Q=1 ml/min (FIG. 5E) was 99.2%, since only 0.8% TB was detected in the inner-outlet of the device. A synthesized sample with 0.8% TB is shown in FIG. 5E for comparison purposes.

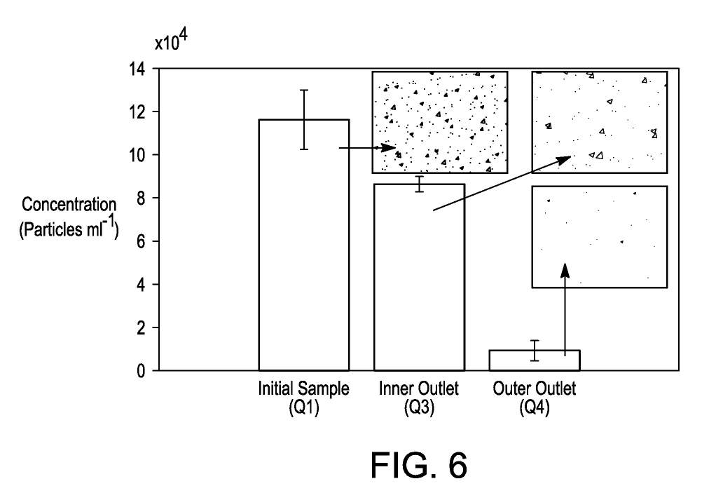

In the present example experimental implementation, the exchanging of the magnetic microparticles' solution involved maintaining the magnetic microparticles proximal to the inner wall of the curve channel while solutions switch their positions laterally along the channel (as illustrated in FIG. 1A). Magnetophoretic concentration and recovery of microparticles was examined on collected samples ran at Q=1 ml/min in the device, with the results shown in FIG. 6. Concentration of particles in the inlet, inner-wall outlet and outer-wall outlet yielded a 90% concentration efficiency and 82% recovery rate of particles (the inventors have found the further refinement can yield recovery rates in excess of 94%). The results shown in the insert to FIG. 6 demonstrate the quality of TB solution exchange simultaneously with particle isolation and concentration at the inner-wall outlet.

The present example demonstrates the potential use of a magnetophoretic separation device for solution exchange of microparticles at a throughput of >10⁴ particles/sec, with high purity. This throughput is approximately ˜10 times higher than that of conventional inertial curved microchannel separation devices.

### Example 2: Semi-Empirical Estimation of Dean Flow Velocity in Curved Microchannels

In this example, the effect of various deterministic parameters on Dean flow velocity in curved microchannels are investigated using simple but practical experimental and numerical approaches. The studied parameters can be categorized into geometrical characteristics (e.g. channel width, height, hydraulic diameter, and radius of curvature) and fluidic properties (e.g. axial velocity and kinematic viscosity). With this comprehensive investigation, a non-dimensionalized correlation is proposed for estimation of V_{De} in curved microchannels (at De<30) that can be used widely for design of curved and spiral microfluidic devices, such as the curved fluidic channels of the devices described the aforementioned example embodiments.

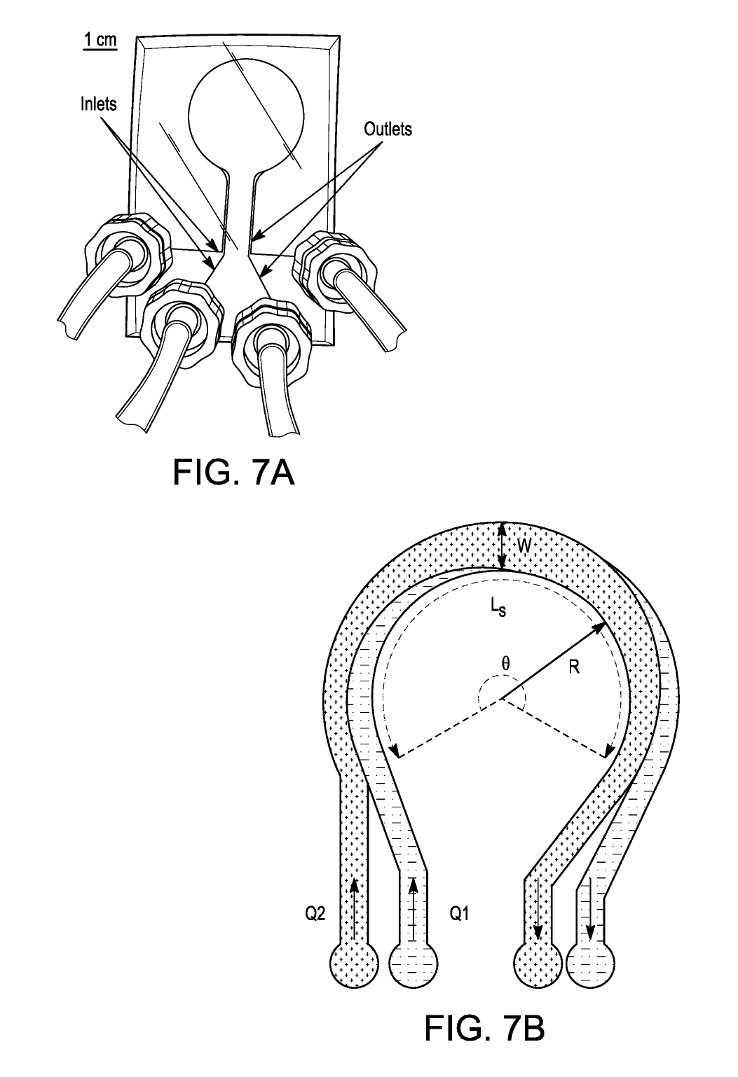

RESULTS AND DISCUSSIONS: The microfluidic devices used in this example study were made of polydimethylsiloxane (PDMS) and consisted of a 330° curved microchannel with two inlets and two outlets as shown in FIG. 7A. The effect of radius of curvature (R=0.5, 1, 1.5 and 2 cm) on fluid recirculation (schematically shown in FIG. 7B) and Dean flow velocity (Voₑ) was investigated in square cross-section (150 μm×150 μm) curved microchannels. Two additional devices with R=1 cm and rectangular cross-sections of 100 μm×150 μm and 300 μm×150 μm were used to investigate the effect of channel dimensions (width, height and hydraulic diameter) on Dean flow velocity. Two additional properties studied were fluid axial velocity (Vₓ) and kinematic viscosity as fully discussed in the following sections.

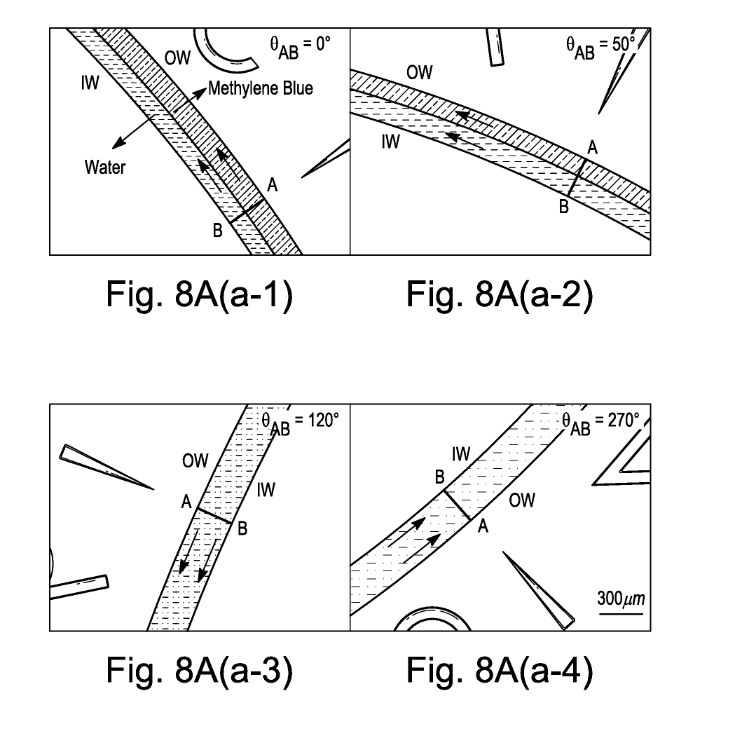

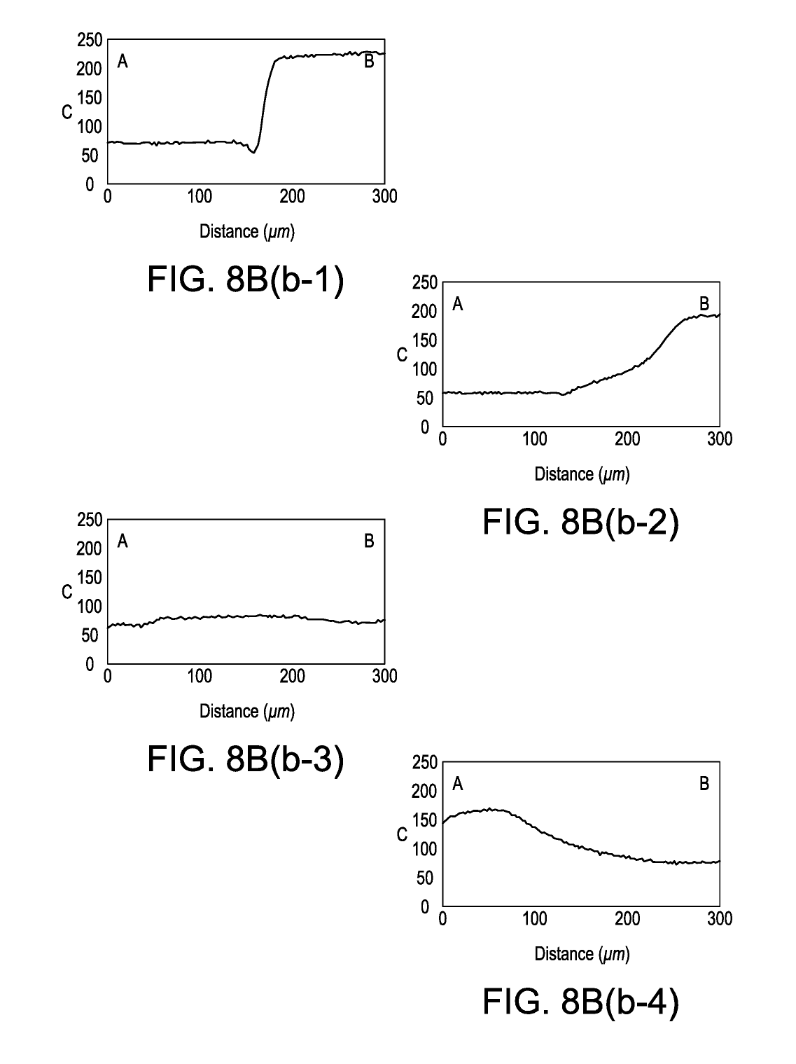

Quantification of Dean Flow in Curved-Channel Microfluidic Devices using a Switching Index (SI): It was decided to first focus on developing a simple and accurate experimental technique to quantify average Dean velocity in the curved-channel microfluidic devices. For this, methylene blue (MB) and water solutions were co-flown into the devices at different axial velocities and videos of fluid recirculation were recorded along the channel under a microscope. The videos were then imported into the freeware ImageJ (National Institutes of Health, Bethesda, Md., USA) for analysis of target cross sections along the curved microchannels. For instance, FIG. 8A shows the snapshots of the R=1 cm device along the channel with a co-flow of water and MB at a flow rate of 0.6 mL min-1 (Vx=0.22 m s⁻¹).

Intensity values (c) across assessment lines (e.g. line AB in FIG. 8A) drawn at 10 degree intervals along the channel were obtained (FIG. 8B) and an average intensity (c̅) for each analyzed line was calculated from the obtained cross-sectional intensity values. To obtain a quantitative assessment of the secondary Dean flow and fluid recirculation, the intensity values obtained in FIG. 8B were used in Equation (4) to calculate the σ-values at each assessment line AB along the channel. Subsequently, a normalized index called the Switching Index (SI) was derived for each assessment line using Equation (5) and plotted along the channel for quantification of Dean flow characteristics such as Dean velocity. The SI was defined based on an index originally used to characterize mixing in microfluidic devices.46 However, diffusive mixing was not significant in the device due to the high axial flow velocities while the SI trends properly represented the lateral displacement of fluids due to Dean flow in the curved microchannels.

$$\begin{matrix}σ = \sqrt{\frac{1}{N} {\sum }_{i = 1}^{N} {( {c}_{i} - \overline{c} )}^{2}} & ( 4 ) \\ SI = σ / {σ}_{ma x} & ( 5 )\end{matrix}$$

In Equation (4), N denotes the number of points analyzed along the assessment line AB at each cross section.

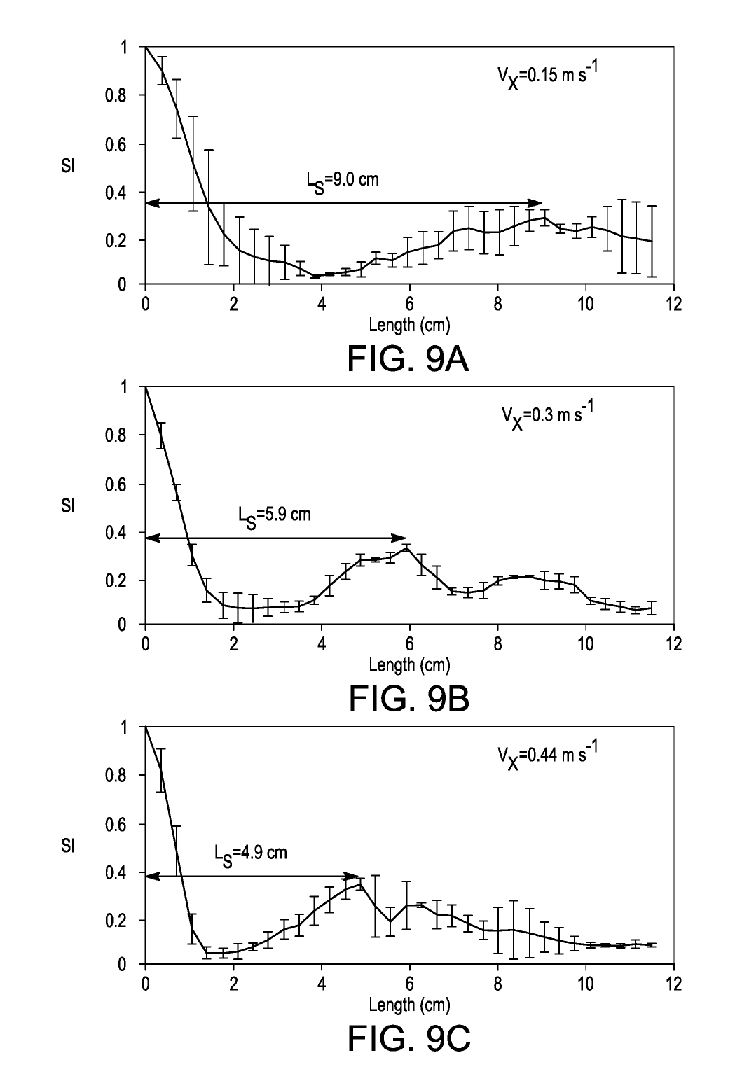

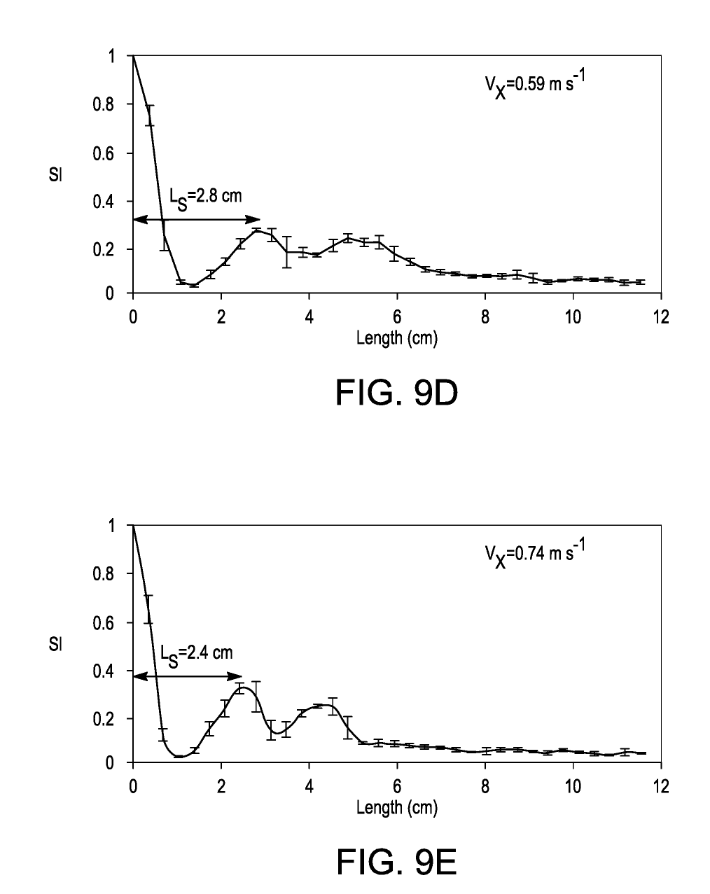

Estimation of Switching Length and Time using the SI: The suitability of the SI in Equation. 5 was assessed for investigating the Dean flow-based recirculation of fluids and quantifying the switching length (Lₛ) and time (t) at which water and methylene blue solutions exchange radial positions in a curved microchannel. For this, a series of experiments were conducted with the microfluidic device that had a radius of curvature of R=2 cm and cross-sectional dimensions of 150 μm×150 μm. Methylene blue and water solutions were co-injected into the device at various axial velocities (Vx=0.15-0.74 ms-1) and the effect of fluid axial velocity on SI was investigated along the channel length. The results are shown in FIGS. 9A-E.

As shown in FIGS. 9A-E, the SI was equal to unity at the entrance of the channel (a=σₘₐₓ in Equation (5)) where the methylene blue and water solutions were completely separated (FIG. 8A-1) and the intensity curve was similar to a step function (FIG. 8B-1). Moving along the length of the channel at each velocity setting, the SI decreased gradually as a result of Dean flow-based recirculation of fluids in the channel (FIGS. 8A-2 and 8B-2). The minimum SI value in each plot was obtained when the water stream was completely sandwiched in between two methylene blue streams at its top and bottom sides (FIG. 8A-3). This condition resulted in a flat intensity diagram (FIG. 8B-3) and minimization of a in Equation (4). Afterwards, the SI started increasing to its first peak value due to continuation of fluids recirculation that resulted in separation of methylene blue and water solutions into two phases in the radial direction of the channel again (180° recirculation in FIGS. 8A-4 and 8B-4). The peak SI value was not equal to the initial unity because of two reasons; first, minor diffusion taking place along the interface of water and methylene blue solutions and second, various fluid particles assuming different local Dean velocities at different locations along the cross section of the channel. These factors prevented achieving a complete switch in fluids' position with an interface as distinct as the one at the channel entrance. They led to an overall reduction of cᵢ and c̅ values in Equation (4) at the location of the switch, hence a smaller SI value in Equation (5). Although these factors resulted in reduction of SI at the first peak, but the switching location (Lₛ) could still be determined from the SI plot which was later used to calculate the average Dean velocity in the channel. By moving further downstream in the channel, fluid recirculation continued to occur and dependent on the fluid velocity, the SI curves either demonstrated a second peak corresponding to a second switch of position or a plateau that indicated indistinguishable mixing of fluid layers in the channel.

As mentioned above, the first peak on the SI diagrams corresponded to the exact switching location of methylene blue and water solutions in the channel which is denoted by the switching length, Lₛ, in FIGS. 9A-E. With increasing the axial velocity of the fluid from 0.15 m s⁻¹ to 0.74 m s⁻¹ (De=2.73-6.82), it is clearly observed that the fluid recirculation became stronger and the SI peaks started to shift towards the left of the diagrams corresponding to reduction of switching length from Lₛ=9 cm (at Vₓ=0.15 m s⁻¹) to Lₛ=2.4 cm (at Vₓ=0.74 m s⁻¹). The switching length Ls and the corresponding axial velocity Vx were used to calculate the time of the first switch (t=Lₛ/Vₓ). The appearance of a second switch (i.e., complete 360° recirculation at the 2nd peak on SI diagrams in FIG. 9E) was identified as the axial velocity was increased in the channel to 0.59 m s⁻¹ and beyond. This was because the vortices got stronger at higher De numbers and switching length decreased resulting in an opportunity for the fluids to show a complete recirculation in the device. Further switches were not identifiable with the quantitative SI-based approach either due to full mixing of the fluids or enhanced 3D complexity in layered structure of the fluids that could no longer be distinguished with the top view-based imaging method.

Estimation of Average Lateral Travel Distance and Dean Velocity: To approximate the average Dean velocity (V_{De}) from the experiments discussed in the previous section, an estimation of the average lateral travel distance by the fluid particles (L_{R}) was needed. In this case, V_{De} can be calculated from Equation (6) using the experimentally determined switching time in the previous section.

$${V}_{De} = \frac{{L}_{R}}{t} = \frac{{L}_{R} {V}_{x}}{{L}_{s}} \qquad ( 6 )$$

The average lateral travel distance was approximated at 0.75D by Ookawara et. al (Okawara, S., Higashi, R., Street, D. & Ogawa, K. Feasibility study on concentration of slurry and classification of contained particles by microchannel. Chem. Eng. J. 101, 171-178 (2004)) by assuming an oversimplified rectangular streamline shape for Dean vortices. However, Martel and Toner (Martel, J. M. & Toner, M. Particle Focusing in Curved Microfluidic Channels. Sci. Rep. 3, 1-8 (2013)) showed that the channel curvature ratio

$$( δ = \frac{D}{2 R} )$$

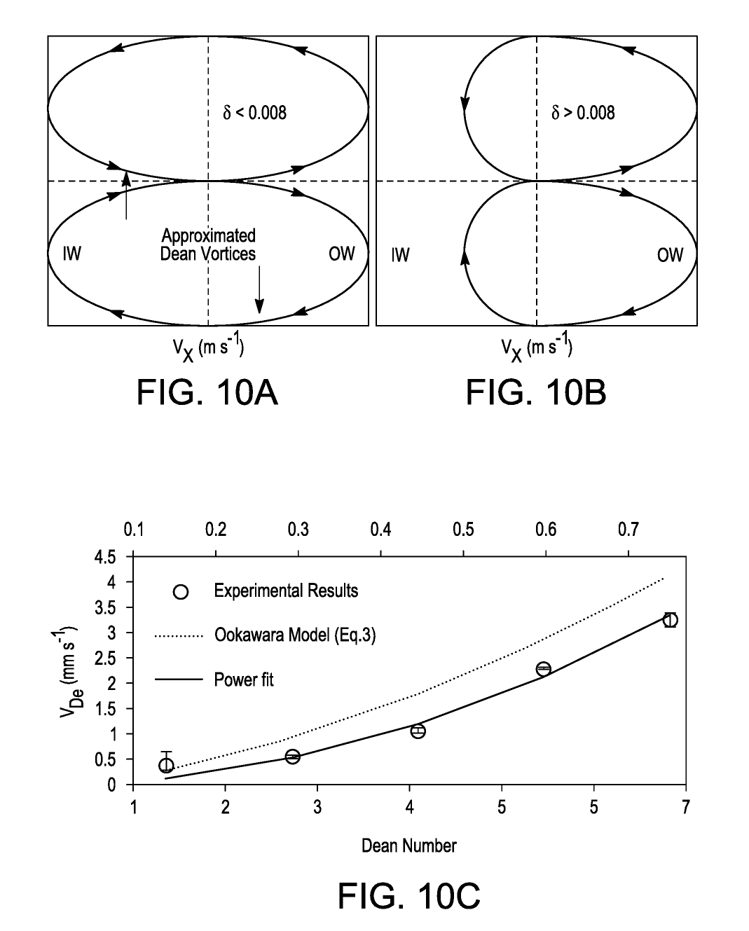

is a key parameter for determination of the shape of Dean vortices. Their simulations (confirmed by the numerical results) indicated that for curvature ratios smaller than 0.008, fluid particles tend to follow elliptical streamlines such as the one shown in FIG. 10A. However, for δ values greater than 0.008, the bulk of the laterally-flowing fluid shifts towards the outer wall of the channel, leading to formation of asymmetric oval shape streamlines for Dean vortices. Hence, the fluid elements closer to the inner wall of the channel participate less in the circulatory motion. Accordingly, the Dean vortices were approximated with elliptical shape streamlines at low δ (<0.008 in FIG. 10A), while a half-circle half-ellipse shape (FIG. 10B) was used to approximate the lateral travel distance, L_{R}, of fluids in channels with higher curvature ratios (δ>0.008). Average Dean velocities for the experiments presented in FIGS. 9A-E were then calculated based on Equation (6) using the approximated L_{R} values discussed above and the results are presented in FIG. 10C.

As demonstrated in FIG. 10C, for a curved microchannel with R=2 cm and cross section of 150 μm×150 μm (elliptical streamline model with δ=0.0038), by increasing the axial velocity of the fluid from 0.15 m s⁻¹ to 0.74 m s⁻¹, the average Dean velocity increased from V_{De}=0.57 mm s⁻¹ to V_{De}=3.25 mm s⁻¹, respectively. This clearly supports the discussion of faster switching of fluids at higher De numbers in a curved microchannel. Following the proposed power equation type (V_{De}=aDe^{b}) by Ookawara et al., a power function was fitted to the calculated V_{De} values in FIG. 10C. The experimentally-driven constants of the fitted equation were a=0.072 and b=2 (R²=0.98) which were different from the numerical values reported by Ookwara et al. (i.e. a=0.18 and b=1.63, R²=0.71).

The power dependence of VDe on the Dean number has been confirmed by others while the disagreement between Ookawara's equation and case-specific models has been reported by researchers such as Guan et al. (Guan, G. et al. Spiral microchannel with rectangular and trapezoidal cross-sections for size based particle separation. Sci. Rep. 3, 1475 (2013)). These differences may be originated from differences in fluid properties and or dimensional variations among different microchannels. Having shown that the methodology has the capability of characterizing the average Dean velocity in a curved microchannel, the investigations were continued by examining the effects of other important parameters such as the radius of curvature, hydraulic diameter, width, height, and viscosity on Dean velocity using a combination of complementary experimental and numerical approaches. The objective of these parametric studies was to explore if an inclusive equation could be proposed for estimation of average Dean velocity in curved microfluidic channels.

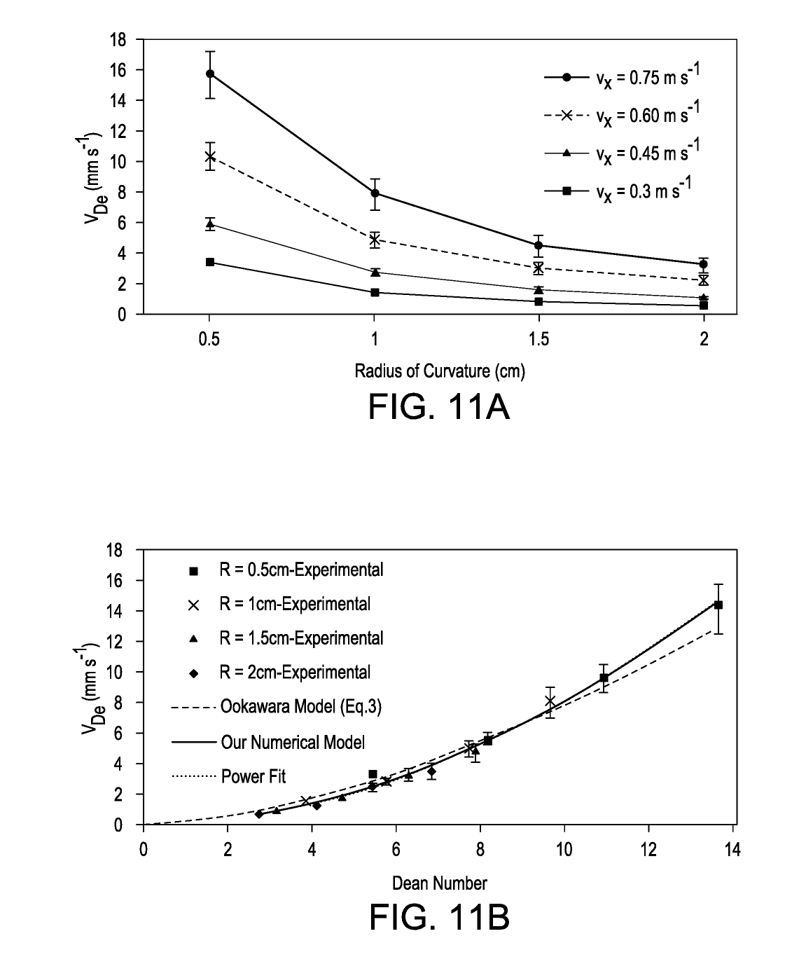

Effect of Channel Radius of Curvature on Dean Velocity: Here, the effect of the radius of curvature of the microchannel on Dean velocity is exaimed. For this purpose, curved microchannels with the same cross section area of 150 μm×150 μm but various radii of curvature of R=0.5, 1, 1.5, and 2 cm were fabricated and tested at various axial flow velocities (Vₓ=0.15-0.74 m s⁻¹). The results of this study are shown in FIG. 11A. As demonstrated, at a constant axial velocity, an increase in the radius of curvature resulted in reduction of Dean velocity due to lowering of the Dean vortex strength. The effect of radius of curvature was more strongly observed at higher axial velocities. The obtained VDe values in the above set of experiments were also plotted as a function of Dean number in FIG. 11B.

For devices that had different radii of curvatures but approximately the same Dean number, a highly similar Dean velocity as shown in FIG. 11B was observed. A power function (V_{De}=aDe^{b}) was fitted to the overall results in FIG. 11B (dotted line) and the correlating constants of a=0.090 and b=1.95 (R²=0.98) were obtained. The Dean velocities from devices with various radius of curvature followed this power correlation precisely, indicating that the effect of radius of curvature is sufficiently captured by the R-parameter already included in the De number. For comparison purposes, the Ookawara's equation is also plotted in FIG. 11B (dashed line). With a R² value of 0.94, it overpredicted the experimental Dean velocities at De<8 and underestimated them at higher De values. It is hypothesized that the mismatch between Ookwara's equation and the experimental results in FIGS. 10B and 11B might stem from the differences between the geometrical dimensions of the curved microchannels and approximated lateral travel distances used in both studies. Therefore, it was decided to develop and validate a numerical model to further investigate the effect of other parameters on Dean velocity.

Numerical Model to Investigate Dean Velocity Parametrically: As discussed in the Methods section, COMSOL Multiphysics was used to simulate the Dean flow in the microchannels and obtain the Dean velocities accordingly. The experimental conditions reported in FIG. 11B were simulated and the numerical results are plotted with a solid black line in FIG. 11B for comparison purposes. The results followed a power function trend (R²=0.98) with a and b coefficients of 0.096 and 1.92, respectively, that were slightly different from the power function fit to the experimental results. This verified that the model could predict Dean velocities with a better precision when compared to the model reported by Ookawara et al. This better precision stems from higher similarity between the numerical simulation and experiments in terms of geometry and flow conditions as well as a better approximation for lateral travel distance of fluid particles as shown in FIGS. 10A and 10B.

The power functions reported in this example and by other researchers for estimation of Dean velocity are limited solely to parameters involved in the Dean number with fixed powers. It is hypothesized that factors such as specific channel geometries (i.e. width vs. height) and fluid viscosity may have significant effects on Dean velocity that available power functions cannot predict accurately. To investigate this, the validated numerical model was used to examine the effect of these parameters on Dean velocity.

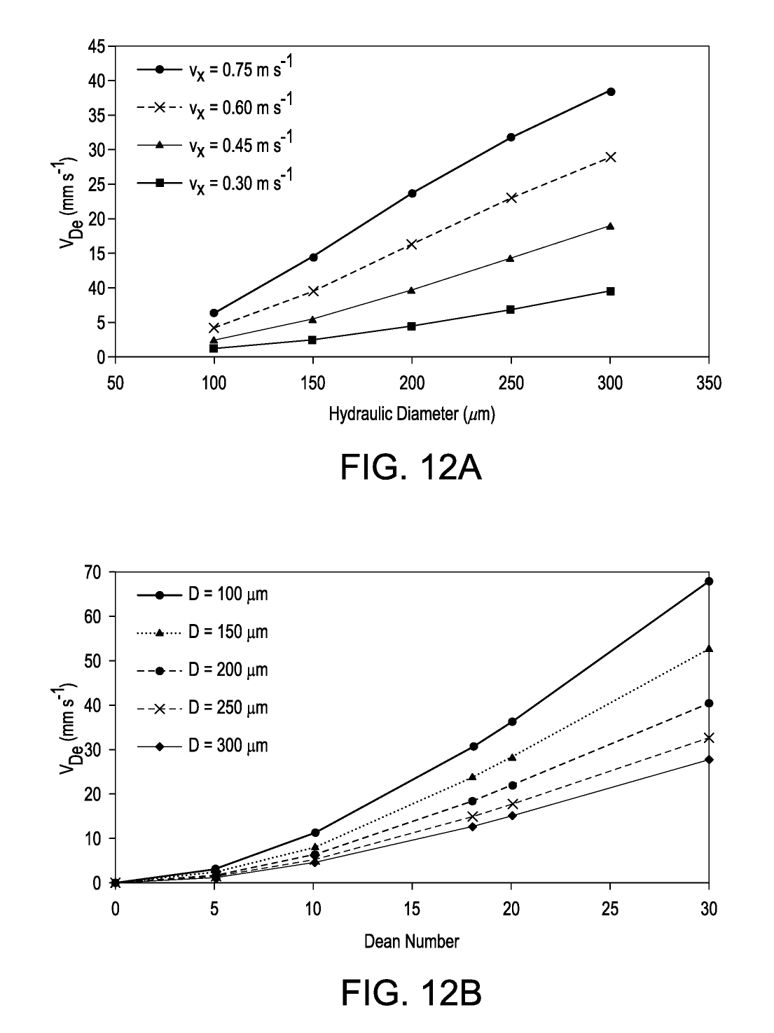

Effect of Hydraulic Diameter on Dean Velocity: The effect of hydraulic diameter of the channel (D) on Dean velocity is captured by a power of 2.92 in the preliminary model presented in previous section (V_{De}=aDe^{b}, a=0.096 and b=1.92). Here, it is investigated whether this power sufficiently captures the effect of hydraulic diameter on Dean velocity. For this purpose, simulations were performed on square cross-section microchannels with R=0.5 cm and hydraulic diameters of 100 μm-300 μm at 0<De<30. It was already showed in FIG. 11B that at a constant De number, the radius of curvature does not affect Dean velocity significantly. Hence, the smallest radius of curvature was selected for numerical investigations of hydraulic diameter which reduced the number of mesh elements and time of computation considerably. Results of these simulations are presented in FIG. 12A. As demonstrated, at a constant axial velocity, an increase in the hydraulic diameter of the channel resulted in an incease in the Dean velocity due to stronger secondary vortices (i.e. higher De numbers). The resulted Dean velocities in the numerical simulations above were also plotted as a function of Dean number in FIG. 12B.

As shown in FIG. 12B, when De number increases at a constant hydraulic diameter, the Dean velocity also increases due to formation of stronger secondary vortices. The results followed a power function (V_{De}=aDe^{b}) similar to what was observed in FIGS. 10B and 11B. However, a single power function with the same coefficients a and b could not be fitted over all the data points, suggesting that the hydraulic diameter parameter with a fixed power could not thoroughly capture the effect of channel geometry on Dean velocity. In other words, increasing the hydraulic diameter while keeping the De number constant resulted in reduction of the Dean velocity which completely contradicts with predictions provided by the power functions presented above or used in various forms in the literature.

The hydraulic diameter is derived from the width and height of the channel. Hence, to further investigate the effect of channel geometry on Dean velocity, the studies were continued with modeling of a series of channels with different widths and heights in the following section.

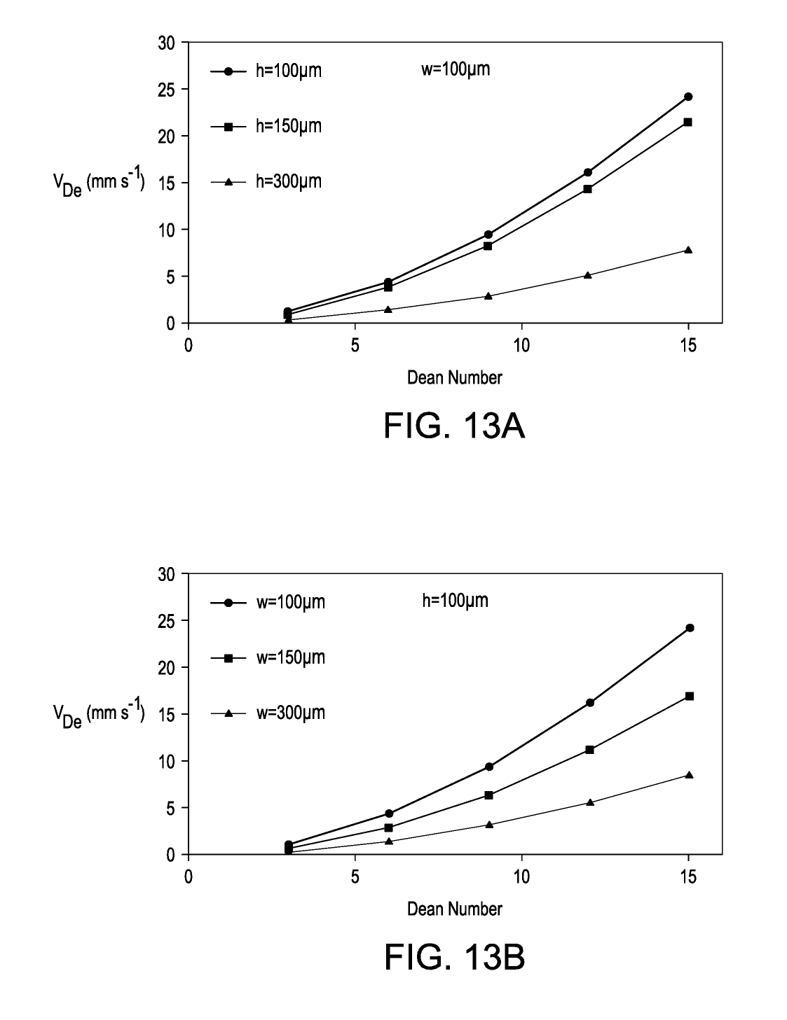

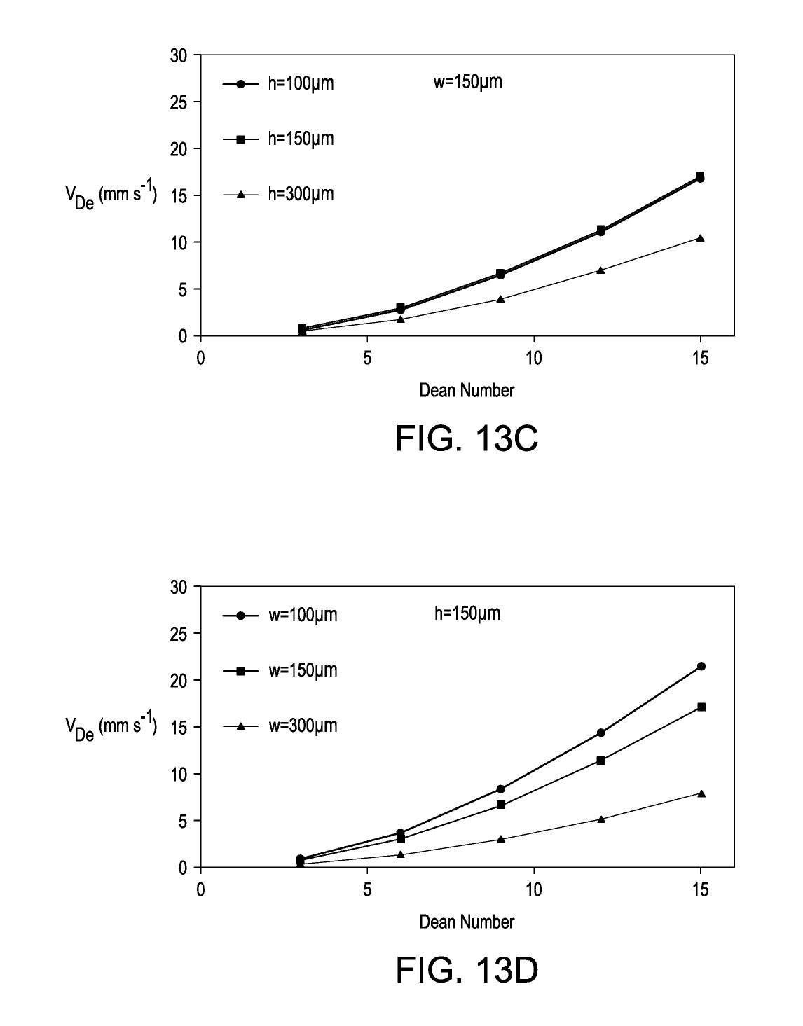

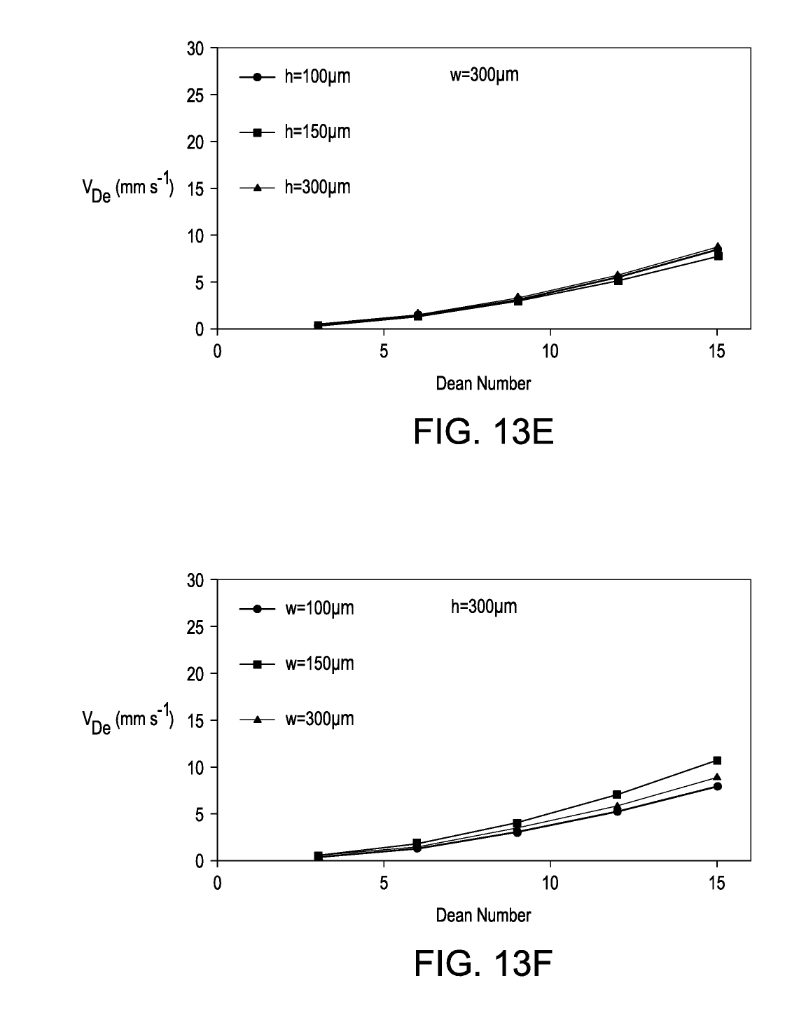

Effect of Channel Width and Height on Dean Velocity: The effect of channel geometry was further investigated by examining the roles of width (w) and height (h) of the channel individually on Dean velocity. the strategy was to simulate 0.5 cm radius of curvature curved microchannels with square and rectangular cross sections that had widths and heights of 100 μm, 150 μm and 300 μm. The resultant Dean velocities for different combinations of channel widths and heights at various De numbers are plotted in FIGS. 13A-F.

As shown in all plots of FIG. 13A-F, increasing the De number at a constant channel width and height expectedly resulted in an increase of Dean velocity. At a constant De number, both height and width had an inverse effect on Dean velocity as shown in FIGS. 13A-C and FIGS. 13D-F, respectively. For instance, increase of channel height from 100 μm to 150 μm to 300 μm at a constant w=100 μm (FIG. 13A) and De=15 resulted in a decrease of Dean velocity from V_{De}=24.2 mm s⁻¹ to V_{De}=21.5 mm s⁻¹ to V_{De}=7.8 mm s⁻¹, respectively. This is because at a constant w, the higher h corresponds to a longer distance that fluid elements should travel in a vortical motion, which results in a lower VDe. However, as the width of the channel became larger, the effect of height on Dean velocity became less dominant. For example, in the 300 μm-wide microchannel (FIG. 13C), changes in height did not significantly affect Dean velocity at any constant De number. Similar trends described above for height were also seen for the effect of width of the channel on Dean velocity as demonstrated in FIGS. 13D-F. Increase of width at a constant height decreased the Dean velocity when De number was maintained constant. However, this decreasing trend became less significant as the height of the channel increased from h=100 μm (FIG. 13D) to h=300 μm (FIG. 13F).

The overall behavior can be explained by introducing the larger dimension of the channel as the determinative parameter influencing the Dean velocity. Channels with equal larger dimension possessed Dean velocities very close to each other and variation in the smaller dimension of the channel had low to no effect on the Dean velocity in all cases. This makes a logical sense because the larger dimension of the channel determines the distance along which fluid particles must travel mostly with their assumed Dean velocities. The results of this section suggested that an additional factor representing the inverse effect of the largest dimension of the microchannel on the Dean velocity should be included in the comprehensive correlation for V_{De}.

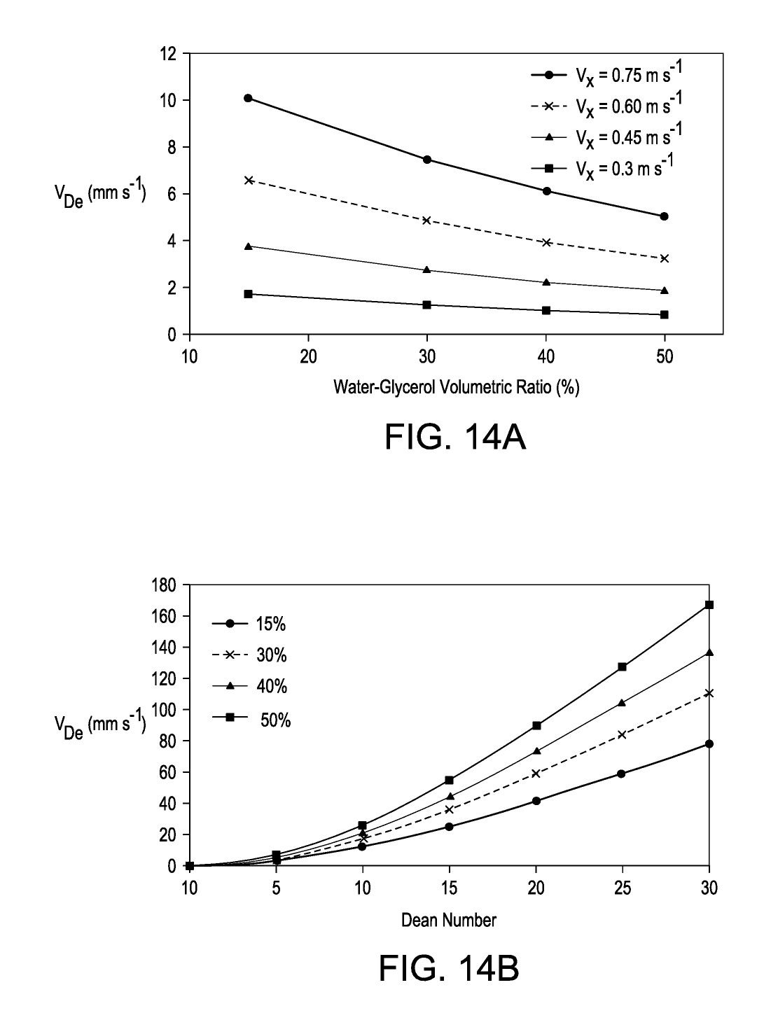

Effect of Kinematic Viscosity on Dean Velocity: Having studied the effects of various channel geometries on Dean velocity, it was investigating whether the kinematic viscosity parameter in the De number is sufficient to capture the effect of this variable on Dean velocity. In other words, it was attempted to understand if changing the viscosity while keeping the De number constant results in any change in the Dean velocity. Therefore, using the numerical model, a microfluidic device was simulated with R=0.5 cm radius of curvature and cross-sectional dimension of 150 μm×150 μm. The kinematic viscosity of the fluids was increased from ν=10⁻⁶ m2 s⁻¹ to ν=3.21×10⁻⁶ m2 s⁻¹ corresponding to 0-50% volumetric water-glycerol mixtures based on the results of Cheng.47 Results of these simulations are presented in FIG. 14A. As demonstrated, at a constant axial velocity, an increase in the viscosity of the fluid resulted in reduction of the Dean velocity due to weakening of the secondary vortices (i.e. lower De numbers). Dean velocities as a function of De number are also plotted in FIG. 14B for the above experiments.

As shown in FIG. 14B, an increase in the De number at each viscosity level causes the Dean velocity to increase by following a power function (V_{De}=aDe^{b}) as observed for other parameters above. However, two fixed values for a and b could not be found to represent all data points with a single power function. Thus, it was concluded that the effect of kinematic viscosity should be included further in the final correlation for V_{De}.

Non-Dimensional Dean Velocity Correlation: Our experimental and numerical results in the previous sections along with other researchers' work has led us to conclude that Dean velocity has a power-function dependency on the De number. However, the existing functions presented in the form of V_{De}=aDe^{b} are not able to represent the effect of some parameters such as the largest channel dimension (s) at all, while not sufficiently capable of capturing the effect of some other parameters such as kinematic viscosity (∪). Here, it is proposed that these parameters should be added to the above formula (i.e. Equation (7)) in order to obtain a more comprehensive correlation for estimation of Dean velocity in curved microchannels.

$${V}_{De} = {a ( \frac{v}{s} )}^{n} {De}^{b} \qquad ( 7 )$$

where a, b and n are the correlation constants that were needed to be determined. In order to find these unknowns, Dean velocities as a function of

$${( \frac{v}{s} )}^{n} {De}^{b}$$

were plotted using all of the numerical results presented before (data not shown). The n and b values were varied in the range of 0.25-2.5 and the best fits to the data points were investigated. For keeping a similarity with the commonly-known Dean power in the literature, b=1.63 was intentionally set. The studies then showed that by setting n=1, the numerical Dean velocities will become linearly dependent on

$$( \frac{v}{s} ) {De}^{1.63}$$

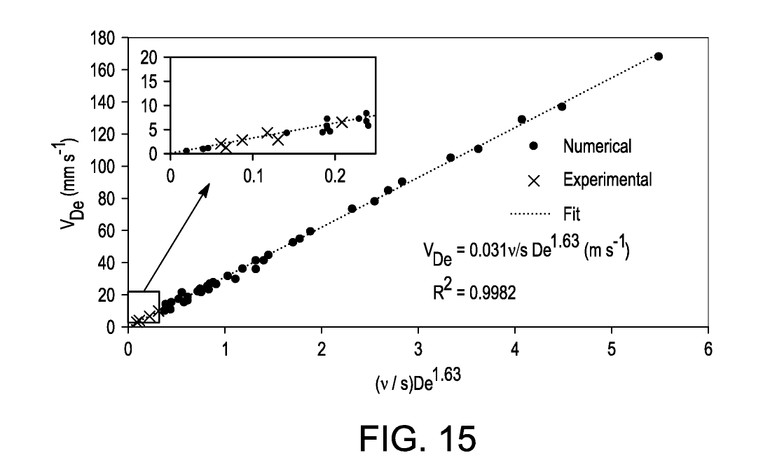

with a constant or linearity of a=0.031 as shown in FIG. 15 (best fit with R2=0.9983).

Based on the studies above, the final correlation for the average Dean velocity in a curved microchannel can be presented as:

$${V}_{De} = 0.031 ( \frac{v}{s} ) {De}^{1.63} \qquad ( 8 )$$

Equation (8) can be rearranged to provide a fully dimensionless relationship between Reynolds number based on Dean velocity and largest dimension of the channel (called lateral Re number) and the De number based on axial velocity.

Re_{s,V}_{_{De}}=0.031 De^{1.63} (9)

Lastly, the suitability of the proposed correlation was experimentally validated. For this purpose, a new set of experiments were conducted in devices with R=1 cm and cross sectional dimensions of 300 μm×150 μm and 100 μm×150 μm. Experiments were also conducted with a 15% volumetric water-glycerol mixture in a device with R=0.5 cm and cross-sectional dimension of 150 μm×150 μm. The resultant experimental Dean velocities are plotted in the inset of FIG. 15. As shown, the proposed correlation in Equation (9) was accurate enough for estimation of Dean velocities in these experiments.

Conclusion: In the present example, experimental and numerical models were developed to examine the effects of radius of curvature, hydraulic diameter, and width and height of the channel as well as the kinematic viscosity of the fluid on Dean velocity in curved microchannels. It was showed that Dean velocity cannot be merely estimated with a widely-used power function (V_{De}=aDe^{b}) because this correlation fails to predict the effects of the larger dimension of the channel and kinematic viscosity on Dean velocity. Instead, it was proposed a semi-empirical correlation that relates the lateral Reynolds number of the channel (based on VDe and the largest channel dimension) to the Dean number. This correlation was accurate enough to predict the average Dean velocity for Dean numbers lower than 30 for various experimental conditions. This correlation may be employed in estimation of Dean velocities in curved and spiral microchannels used widely in sample processing and preparation applications.

Device Fabrication: Standard photolithography and soft lithography methods were used to fabricate the abovementioned microfluidic devices. In order to prepare the master replication molds, negative SU8 2075 photoresist (Microchem Corp., MA, USA) was spun over 4-in diameter silicon wafers which were obtained from University Wafers Corp. (MA, USA). Coated wafers were then prebaked at 65° C. for 5 minutes and 95° C. for 30 minutes followed by exposure to ultraviolet light through a photomask. Post-bake treatment was carried out at 65° C. and 95° C. for 5 and 12 minutes, respectively. The process was finalized by dissolving the unexposed SU8 using SU8 developer solution. Subsequently, degassed mixture of 10:1 ratio PDMS pre-polymer base and curing agent (Sylgard 184 kit, Dow Corning, MI, USA) was poured over the mold and heated at 80° C. for 2 hr. The cured PDMS layer was peeled off the master mold and holes were punched on it at inlets and outlets of the microchannel. In order to enclose the microchannel, an oxygen plasma machine (Harrick Plasma, PDC-001, NY, USA) was used to bond cured PDMS layers with glass slides at 45 W for 30-35 s, followed by heating at 80° C. for 5-10 minutes to enhance the bonding. To prepare the device for experiments, Tygon tubes (Saint-Gobain, Paris, France) were connected to the punched inlets and outlets of the bonded device.

Experimental Setup and Procedures: Two 10 mL syringes containing Methylene Blue (MB) dyed and tap water were installed onto a dual syringe pump (Legato 110, KD Scientific, USA) and used to co-flow the fluids with favorable flow rates into the microfluidic device that was positioned under a microscope for optical imaging. In order to investigate the effect of viscosity on Dean velocity, a water and glycerol mixture with 15% volumetric ratio was used while viscosity and density values of the mixture were calculated from the work of Cheng (Cheng, N.-S. Formula for the Viscosity of a Glycerol-Water Mixture. Ind. Eng. Chem. Res. 47, 3285-3288 (2008). Inlet flow rate was changed from 0.2-1 mL min⁻¹ (corresponding to axial velocity of Vₓ=0.15-0.74 m·s⁻¹ and Re=22.5-112.5) and flow was allowed to stabilize in the devices for 2 min. After flow stabilization, a video from the entire channel, from inlet to outlet, was recorded at a 5× magnification via a camera (Point Grey, BC, Canada) connected to the inverted microscope (Bioimager, ON, Canada). Devices were properly washed after each experiment with water for at least 5 minutes to remove any MB residue. Experiments were repeated at least three times for each flow rate and viscosity setting to obtain average and standard deviation values at each experimental condition.

Numerical Model: COMSOL Multiphysics was used to simulate the above-mentioned curved microchannels used in the experiments. Approximately 10⁵-10⁶ mesh elements were used in each simulation depending on the size of the microchannel to make the simulations mesh-independent. Inlet velocity and atmospheric pressure boundary conditions were employed for the inlets and outlets, respectively. The channel walls were all set to no-slip boundary condition. The average V_{De} was calculated by deriving the average tangential velocities over the cross section of the channel normal to the wall. The size of the modeled channel was decreased to a shorter length to enhance the computation speed and accuracy. The average V_{De} along the channel was calculated and no significant changes in V_{De} was observed after 60°, so only a 60° portion of the channel was modeled. The final reported V_{De} was calculated at the cross-section located 10° before the outlet to prevent the outlet condition to affect the results.

Although the foregoing has been described with reference to certain specific embodiments, various modifications thereto will be apparent to those skilled in the art without departing from the spirit and scope of the invention as outlined in the appended claims.

1. A fluidic system comprising:
a curved fluidic channel;
a first inlet channel and a second inlet channel, wherein each inlet channel is in fluidic communication with a proximal region of said curved fluidic channel;
a first liquid flow device in fluid communication with said first inlet channel for directing a first liquid into said curved fluidic channel;
a second liquid flow device in fluid communication with said second inlet channel for directing a magnetic microparticle suspension comprising a second liquid and magnetic microparticles into said curved fluidic channel,
wherein said first inlet channel and said second inlet channel are configured such that the first liquid initially flows in a first laminar flow stream proximal to a first side of said curved fluidic channel, and such that the magnetic microparticle suspension initially flows in a second laminar flow stream proximal to a second side of said curved fluidic channel,
wherein a length of said curved fluidic channel is selected to effect inversion of the first liquid and the second liquid via Dean flow, such that within a distal region of said curved fluidic channel, the second liquid flows in a third laminar flow stream proximal to said first side of said curved fluidic channel, and the first liquid flows in a fourth laminar flow stream proximal to said second side of said curved fluidic channel;
one or more magnets positioned relative to said curved fluidic channel such that a magnetic field gradient is established across a width direction of said curved fluidic channel as Dean flow occurs along said curved fluidic channel exerting a force on the magnetic microparticles in the width direction such that the magnetic microparticles are retained proximal to said first side of said curved fluidic channel as the magnetic microparticles flow through said curved fluidic channel, and such that the magnetic microparticles reside predominantly within the third laminar flow stream in said distal region of said curved fluidic channel effecting solution exchange of the first liquid and the second liquid relative to the magnetic microparticles; and
a first outlet channel and a second outlet channel, wherein each outlet channel is in fluidic communication with said distal region of said curved fluidic channel such that the third laminar flow is directed to said first outlet channel and the fourth laminar flow stream is directed to said second outlet channel.

2. The fluidic system of claim 1 wherein at least one of the width, height and length of said curved fluidic channel and a flow rate of the magnetic microparticle suspension are selected such that, in the absence of said one or more magnets, inertial forces alone would be insufficient to retain the magnetic microparticles proximal to said first side of said curved fluidic channel as the magnetic microparticles flow through said curved fluidic channel.

3. The fluidic system of claim 1 wherein said one or more magnets are positioned such that the magnetic field gradient is approximately uniform along at least a portion of said curved fluidic channel.

4. The fluidic system of claim 1 wherein said one or more magnets is a cylindrical magnet surrounded at least in part by said curved fluidic channel.

5. The fluidic system of claim 1 wherein said one or more magnets comprises a plurality of magnets arranged beyond an outer convex side of said curved fluidic channel.

6. The fluidic system of claim 1 wherein said first side of said curved fluidic channel is an inner concave side of said curved fluidic channel, and wherein a magnetic force resulting from the magnetic field gradient is configured to retain the magnetic microparticles proximal to said inner concave side.

7. The fluidic system of claim 1 wherein said first side of said curved fluidic channel is an outer convex side of said curved fluidic channel, and wherein a magnetic force resulting from the magnetic field gradient is configured to retain the magnetic microparticles proximal to said outer convex side.

8. The fluidic system of claim 1 wherein magnetic properties of the magnetic microparticles and magnetic susceptibilities of the first liquid and the second liquid are selected such the magnetic force is attractive.

9. The fluidic system of claim 1 wherein magnetic properties of the magnetic microparticles and magnetic susceptibilities of the first liquid and the second liquid are selected such the magnetic force is repulsive.

10. A method of performing solution exchange within a curved fluidic channel, the method comprising:
directing, into a proximal region of the curved fluidic channel, a first liquid and a magnetic microparticle suspension, the magnetic microparticle suspension comprising a second liquid and magnetic microparticles, the first liquid and the magnetic microparticle suspension deliverable to the curved fluidic channel such that the first liquid initially flows in a first laminar flow stream proximal to a first side of the curved fluidic channel and such that the magnetic microparticle suspension initially flows in a second laminar flow stream proximal to a second side of the curved fluidic channel;
while applying a magnetic field gradient along a width direction of the curved fluidic channel, flowing the first liquid and the magnetic microparticle suspension over a length of the curved fluidic channel suitable for effecting inversion of the first liquid and the second liquid via Dean flow, such that the second liquid forms a third laminar flow stream proximal to the first side of the curved fluidic channel, and the first liquid forms a fourth laminar flow stream proximal to said second side of the curved fluidic channel,
wherein the magnetic field gradient is configured to exert a force on the magnetic microparticles in the width direction such that the magnetic microparticles are retained proximal to the first side of the curved fluidic channel as the magnetic microparticles flow through the curved fluidic channel, and such that the magnetic microparticles reside predominantly within the third laminar flow stream effecting solution exchange of the first liquid and the second liquid relative to the magnetic microparticles; and
collecting the third laminar flow stream in a first outlet channel and the fourth laminar flow stream in a second outlet channel.

11. The method of claim 10 wherein the width, height and length of the curved fluidic channel and a flow rate of the magnetic microparticle suspension are selected such that, in the absence of the magnetic field gradient, inertial forces alone would be insufficient to retain the magnetic microparticles proximal to the first side of the curved fluidic channel as the magnetic microparticles flow through the curved fluidic channel.

12. The method of claim 10 wherein the length of the curved fluidic channel is selected to correspond to a half Dean cycle.

13. The method of claim 10 wherein the magnetic microparticle suspension is flowed at a rate between 0.1 ml/min and 1 ml/min.

14. The method of claim 10 wherein the magnetic microparticle suspension is flowed at a rate between 1 ml/min and 10 ml/min.

15. The method of claim 10 wherein the curved fluidic channel is provided as an arc spanning less than 360 degrees.

16. The method of claim 15 the magnetic field gradient is uniform along the arc in a length direction.

17. The method of claim 10 wherein the first side of the curved fluidic channel is an inner concave side of the curved fluidic channel, and wherein a magnetic force resulting from the magnetic field gradient is configured to retain the magnetic microparticles proximal to the inner concave side.

18. The method of claim 10 wherein the first side of the curved fluidic channel is an outer convex side of the curved fluidic channel, and wherein a magnetic force resulting from the magnetic field gradient is configured to retain the magnetic microparticles proximal to the outer convex side.

19. The method of claim 10 wherein magnetic properties of the magnetic microparticles and magnetic susceptibilities of the first liquid and the second liquid are selected such the magnetic force is attractive.

20. The method of claim 10 wherein magnetic properties of the magnetic microparticles and magnetic susceptibilities of the first liquid and the second liquid are selected such the magnetic force is repulsive.
